(19) United States
(12) Patent Application Publication
(10) Pub. No.: US 2026/0332592 A1
(43) Pub. Date: Oct. 22, 2026

(54) SYSTEM

(71) Applicant: SoftBank Group Corp., Tokyo (JP)

(72) Inventor: Kenichiro YOKOTA, Tokyo (JP)

(73) Assignee: SoftBank Group Corp., Tokyo (JP)

(21) Appl. No.: 19/650,341

(22) Filed: Apr. 17, 2026

(30) Foreign Application Priority Data
Apr. 21, 2025 (JP) 2025-070015

(51) Int. Cl. H04L 9/40

(52) U.S. Cl. CPC H04L 63/10; H04L 63/1425; H04L 63/20

(57) ABSTRACT

The present invention relates to an integrated ID management system comprising a user information management unit, an authorization management unit, an audit record management unit, a generative AI processing unit, and the like, and automatically formulating and applying a principle of least privilege policy by analyzing an attribute, a business content, a past authority assignment record, and the like of each staff member using generative AI, for the purpose of efficiency improvement and security enhancement of account and authority management of a large number of outsourced staff members in a telecommunications industry or an IT-related company. Furthermore, it is characterized by automatic assignment, change, and revocation of an authority according to an event such as joining, transfer, and retirement, detailed collection of an audit record and abnormality detection, inter-system synchronization by API cooperation, realization of single sign-on, and the like.

### CROSS-REFERENCE TO RELATED APPLICATION

The present application claims priority to and incorporates by reference the entire contents of Japanese Patent Application No. 2025-070015 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is wide-ranging, such as the complication of account management work that occurs when accepting a large number of outsourced staff members in a telecommunications industry or an IT-related company, that is, an increase in management burden due to individually issuing and managing a system authority for each staff member, an increase in the risk of information leakage and unauthorized access due to an authority setting error, a lack of internal accumulation of know-how due to personalization of system management work, an increase in account issuance and management costs, and an occurrence of a time lag until the start of business due to a procedural delay, and in order to solve these problems, an object of the present invention is to simultaneously realize centralization of account and authority management among a plurality of systems, automatic update of an account and an authority at the time of joining, transfer, and retirement by integration of a directory service and cooperation with a human resource system, automatic application of a principle of least privilege policy defined for each department and each job title, efficiency improvement of inter-system communication by API cooperation, consistent authentication management in a hybrid environment by integration of a cloud infrastructure and an on-premises environment, recording of an access history and facilitation of a tracking investigation by an audit log function, elimination of personalization and accumulation of know-how, and further cost reduction and business efficiency improvement, by introducing an integrated ID management system utilizing generative AI.

### SUMMARY OF THE INVENTION

As a means for solving the problem, a system comprising a user information management unit, an authorization management unit, an audit record management unit, and a generative AI processing unit is configured, wherein the user information management unit centrally manages individual attribute information, an affiliated department, a job title, and an enrollment status of an outsourced staff member engaged in a telecommunications industry or an IT-related business, the authorization management unit automatically formulates a principle of least privilege policy according to the affiliated department and the job title of each user using generative AI, and further executes assignment, change, and revocation of an authority in real time in cooperation with event information such as joining, transfer, and retirement from a human resource system, the audit record management unit records all account operations, authority changes, and system access histories together with time information, and the generative AI processing unit analyzes information of each of these units, automatically detects an authority setting error and a sign of unauthorized access, further performs information synchronization with an authentication infrastructure of a cloud infrastructure or an on-premises environment through API cooperation, and realizes consistent ID management and security risk reduction in a hybrid environment.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

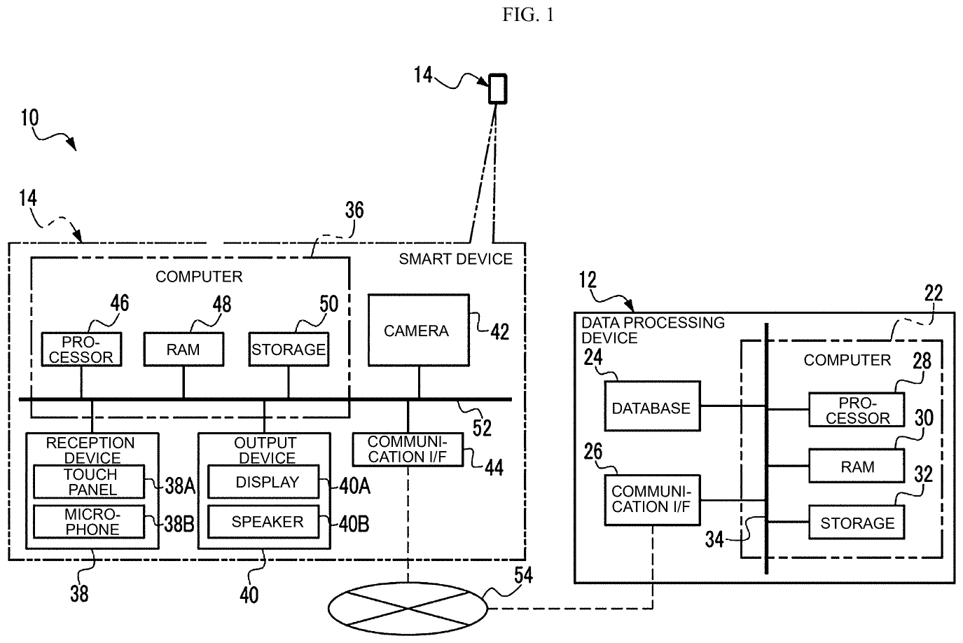

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

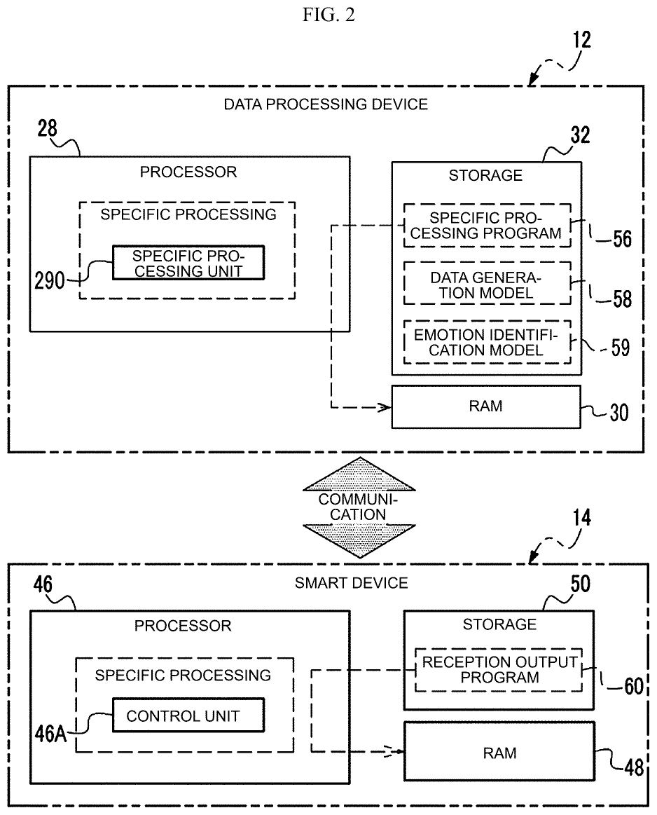

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

As an embodiment for carrying out the present invention, a configuration in which a server and a terminal are connected via a network is adopted, a user information management unit, an authorization management unit, an audit record management unit, and a generative AI processing unit are implemented on the server side, and a user interface unit and a part of an authentication processing unit are implemented on the terminal side. Hereinafter, the configuration and function of each unit, a specific utilization method of generative AI, role sharing between the server and the terminal, and further specific examples will be described in detail. Specifically, the present system functions as an integrated ID management infrastructure on a scale of tens of thousands of people in a large-scale multinational corporation. The present system includes a parallel computing cluster using an image processing semiconductor as a hardware configuration. The present server connects a plurality of computing nodes with a high-speed network interface. The present server deploys a distributed in-memory database on a memory. The present server containerizes and executes each management unit as a microservice architecture. The present terminal executes a web browser or a dedicated client application. The present terminal communicates with the present server via a secure encrypted communication protocol. The present system distributes a processing load to a plurality of server nodes. The present system reduces a communication delay. The present system eliminates a single point of failure. The present system realizes high availability and scalability. The present system completely eliminates conventional manual authority management work by a human. The present system dramatically improves the processing efficiency of computer technology itself.

First, the user information management unit operates on the server, and centrally manages a wide variety of attribute information such as a name, an employee number, an affiliated department, a job title, an enrollment status (enrolled, retired, transferring, etc.), contact information, a business start date, a scheduled business end date, a project in charge, a system scheduled to be used, a past transfer history, a skill set, qualification information, and emergency contact information of an outsourced staff member in a database. For example, in order to efficiently manage information of more than 22,000 outsourced staff members, a distributed database, a clustering technology, and a database sharding technology can be used on the server side. Furthermore, the user information management unit performs API cooperation with a human resource system or an external contract management system, receives event information such as joining, transfer, retirement, contract renewal, and contract termination in real time, and automatically updates user information. For example, when a certain staff member is assigned to a new project, the user information management unit receives an API notification from a project management system and immediately reflects information on the project in charge. Specifically, the present user information management unit adopts a document-oriented non-relational database. The present database stores the attribute information of each user as a hierarchical key-value format data structure. The present user information management unit uses a stateless communication architecture for communication with an external system. The present user information management unit receives a payload in a data exchange format from the external system. The present user information management unit executes parsing of the received payload. The present user information management unit converts the extracted attribute data into a multidimensional numerical vector. The present user information management unit indexes and stores the converted numerical vector in a vector database. The present process dramatically improves a data search speed. The present process ensures data consistency between systems in milliseconds. The present system is extremely effective in an information and communication technology development site where a project structure frequently changes. The present system reduces data management overhead and improves utilization efficiency of a storage area of a computer.

The authorization management unit operates on the server, comprehensively analyzes an affiliated department, a job title, a business content, a past authority assignment record, a system usage history, project information, a skill set, qualification information, and the like of each user using generative AI, and automatically formulates a principle of least privilege policy. For example, the AI automatically determines an optimal authority set for each department, job title, and business content, such as assigning “management authority for a source code management system”, “access authority to a development environment”, “authority to use all functions of a project management tool”, and the like to a manager of a development department, and assigning only “viewing authority for a customer information management system” and “input authority for an inquiry response system” to a staff member of a CS department. Furthermore, the AI continuously learns past authority assignment histories and access logs, automatically extracts an exceptional pattern such as “additional authority is required when assigned to a specific project even with the same job title”, for example, and flexibly updates an authority assignment rule. By API cooperation from the human resource system, event information such as joining, transfer, retirement, contract renewal, and contract termination is received in real time, and assignment, change, or revocation of an authority of a corresponding user is immediately executed. For example, in a case of transfer from the development department to the CS department, the AI detects a transfer event, automatically revokes the “management authority for the source code management system” assigned in the development department, and newly assigns only the “viewing authority for the customer information management system” of the CS department. At the time of retirement or contract termination, the AI automatically deletes an account of the corresponding user from all related systems and revokes all authorities. Furthermore, the AI also copes with a complicated case such as “a case where the same user has an authority across a plurality of departments” or “temporary authority assignment for temporary project participation”, assigns an authority only for a necessary period, and automatically revokes the authority after the period ends. Specifically, the present authorization management unit implements a neural network based on a large language model. Input data to the present neural network is a 768-dimensional numerical vector indicating attribute information of a user. The present input data includes a department identifier, a job title identifier, and a skill vector as elements. The present neural network executes a matrix operation using a self-attention mechanism on the input data. Output data from the present neural network is a one-dimensional numerical array having a continuous value from 0.0 to 1.0 indicating an access permission probability to each system. A first element of the present output data indicates an assignment probability of the management authority for the source code management system. A second element of the present output data indicates an assignment probability of the viewing authority for the customer information management system. The present authorization management unit determines whether or not the output probability value exceeds a threshold value of 0.8. The present authorization management unit validates a corresponding authority assignment flag when the threshold value is exceeded. The present neural network continuously updates a weight parameter by an error backpropagation method using a cross-entropy error function. The present process mathematically prevents excessive authority assignment. The present process reduces an information leakage risk and improves a security level of the entire system. The present system realizes unconventional rule-based processing that does not depend on human intuition.

The audit record management unit operates on the server, and records in detail all account operations (new registration, information update, deletion), authority changes (assignment, change, revocation), system access histories (login, logout, operation content), data synchronization histories with an external system by API cooperation, and terminal information (IP address, terminal identifier, used browser information, etc.) together with time information. For example, when a user is newly registered, from which terminal, which administrator assigned what kind of authority, and to which system an account was issued are recorded in detail, enabling a search and a follow-up investigation at a later date. Furthermore, the audit record management unit can also use a blockchain technology or an electronic signature technology to prevent falsification of an audit log. For example, for an important authority change or account deletion operation, multi-factor authentication of an administrator is required, and an electronic signature is added to the operation record, thereby preventing subsequent falsification and repudiation. Specifically, the present audit record management unit constructs a hash chain structure based on a distributed ledger technology on a memory. The present audit record management unit inputs each operation log data to a cryptographic hash function. The present audit record management unit outputs a 256-bit fixed-length hash value. The present audit record management unit combines a hash value of immediately preceding log data with current log data. The present audit record management unit calculates a new hash value from the combined data. The present audit record management unit generates an electronic signature by a private key of the administrator using an elliptic curve cryptography algorithm. The present audit record management unit adds the generated electronic signature to the log data. The present audit record management unit stores the log data in a time-series database. The present audit record management unit constructs an inverted index to optimize an execution speed of a search query. The present process mathematically guarantees integrity of the log data. The present process makes ex-post data falsification physically impossible. The present system is extremely effective in an environment where strict compliance requirements are demanded, such as a financial institution or a medical institution. The present system completely automates audit response work and reduces a processing load of a computer.

The generative AI processing unit operates on the server, and integrally analyzes diverse data such as user information, authority assignment histories, audit records, system usage statuses, and event information from an external system. For example, the AI learns past authority assignment records, business contents, and system usage frequencies, and continuously updates an optimal authority assignment policy. The AI detects an unusual access or authority change in real time using an anomaly detection algorithm, automatically extracts an abnormal pattern such as “a user who does not usually access accessed an important system in a midnight time zone”, “the same user repeated authority changes in a plurality of systems in a short time”, or “an account of a retired user was illegally used”, for example, and performs risk notification to an administrator. The AI analyzes an authority setting error and a tendency of personalization from an operation history of the administrator and past audit records, automatically reports a risk such as “authority assignment errors by a specific administrator frequently occur” or “authority setting in a specific department deviates from a standard”, and can also propose a necessity of a corrective measure or education. Specifically, the present generative AI processing unit implements an anomaly detection model using a long short-term memory network. Input data to the present anomaly detection model is a 128-dimensional time-series tensor including an access frequency in the past 24 hours and a geographical distance score of an Internet Protocol address as elements. The present anomaly detection model calculates a hidden state vector from the input time-series tensor. Output data from the present anomaly detection model is an anomaly score represented by a continuous value from 0.0 to 1.0. The present generative AI processing unit determines whether or not the output anomaly score exceeds a threshold value of 0.85. The present generative AI processing unit generates a control signal for immediately locking an account of a corresponding user when the threshold value is exceeded. The present generative AI processing unit transmits the control signal to an authentication infrastructure. The present generative AI processing unit push-notifies a warning message to a terminal of the administrator. The present process blocks an internal fraud in a zero-trust network environment in milliseconds. The present process realizes pattern recognition in a high-dimensional space exceeding a limit of human monitoring capability. The present system dramatically reduces an occurrence probability of a security incident.

In addition, the generative AI also performs information synchronization with an authentication infrastructure of a cloud infrastructure or an on-premises environment through API cooperation. For example, for diverse systems such as a cloud storage service, groupware, a business application, a virtual desktop, a mail system, a file server, and a network device management system, the AI automatically analyzes an API specification and an authentication protocol of each system, and appropriately converts and synchronizes necessary authentication information and authority information. For example, when a new folder is created in the cloud storage service, the AI detects the event and automatically assigns an access authority only to a staff member of a corresponding department. Alternatively, when an outsourced staff member retires, the AI automatically deletes an account of a corresponding user from all related systems, and records all deletion histories as an audit record. Specifically, the present generative AI processing unit automatically analyzes a specification document of an external system using a natural language processing model. Input data to the present natural language processing model is a text tensor describing an interface specification of the external system. The present natural language processing model extracts a uniform resource locator of an endpoint, an essential parameter, and an authentication method from the text tensor. Output data from the present natural language processing model is a data object in which the extracted information is structured. The present generative AI processing unit dynamically generates a request message of a hypertext transfer protocol based on the output data object. The present generative AI processing unit transmits the generated request message to a target system. The present process completely eliminates manual programming man-hours required for system integration. The present process prevents a communication error due to a setting error. The present system minimizes latency of data synchronization in a heterogeneous environment. The present system dramatically improves operational efficiency of the entire computer network.

A user interface unit is implemented on the terminal side, and provides a screen for an outsourced staff member or an administrator to confirm his/her own account information and authority status, and to perform an application and an approval. For example, when a staff member applies for use of a new business system, application information is transmitted from the terminal to the server, the generative AI on the server side analyzes an application content, automatically determines whether or not a necessary authority is appropriate, and returns feedback of approval or rejection to the terminal. The administrator can browse an audit record and a risk alert by the AI from the terminal, and instruct an additional investigation and a corrective measure as necessary. Furthermore, a part of an authentication processing unit is implemented on the terminal side, and spoofing and unauthorized access are prevented by combining multi-factor authentication, biometric authentication, terminal authentication, and the like. For example, when the administrator performs an important authority change, one-time password authentication or fingerprint authentication is requested on the terminal, and an authentication result thereof is transmitted to the server to permit an operation. Specifically, the generative AI processing unit on the present server side includes an inference engine that determines appropriateness of the application content. Input data to the present inference engine is a natural language text describing an application reason and a numerical vector indicating a current authority state of a user. The present inference engine calculates a semantic similarity between the input data. Output data from the present inference engine is an approval recommendation score represented by an integer value from 0 to 100 and a text character string of a rejection reason. The present server executes an automatic approval process when the approval recommendation score is 90 or more. The present server executes an automatic rejection process when the approval recommendation score is less than 50. The authentication processing unit on the present terminal side processes an image tensor acquired from a fingerprint sensor. The present authentication processing unit extracts a feature point from the image tensor and calculates a hash value. The present authentication processing unit transmits the calculated hash value to the present server. The present process avoids direct transmission of a biometric image that consumes a network bandwidth. The present process eliminates a bottleneck of an approval process and minimizes business downtime. The present system reduces a cognitive load of the administrator and improves response performance of a computer.

Also, for example, the AI can analyze past audit records, extract a tendency of an authority setting error frequently occurring in a specific department or job title, and propose a necessity of a policy review or education to an administrator. The AI continuously learns changes in business contents and system usage statuses of outsourced staff members, automatically generates an optimal authority assignment rule even when a new business system is introduced, for example, and significantly reduces a burden on the administrator. Furthermore, the AI can also automatically control authority assignment to “a system accessible only by a staff member having a specific qualification”, for example, based on a skill set and qualification information of the outsourced staff member. Specifically, the present generative AI processing unit extracts a pattern on a high-dimensional data space using a clustering algorithm. Input data to the present clustering algorithm is a multidimensional matrix combining past authority change histories and incident histories. The present generative AI processing unit calculates a Euclidean distance between data points and forms a cluster. Output data from the present clustering algorithm is a cluster centroid vector indicating a high-risk authority setting pattern. The present generative AI processing unit calculates a similarity between a vector of a new authority setting request and the cluster centroid vector. The present generative AI processing unit automatically blocks the setting request when the similarity exceeds a predetermined threshold value. The present generative AI processing unit executes an optical character recognition process on image data of a qualification certificate. The present generative AI processing unit specifies a qualification name and an expiration date from the extracted text using a named entity recognition model. The present process realizes proactive risk management as an autonomous operation of a computer. The present process prevents a compliance violation in advance. The present system eliminates human visual confirmation work and dramatically improves a processing speed.

Furthermore, for example, the AI centrally manages authentication information of a plurality of cloud services and on-premises systems, and enables a user to access various systems from a terminal by single sign-on. For example, when a staff member is authenticated once on the terminal, the AI automatically generates an authentication token of each system, and the user can seamlessly access a business application, a cloud storage, a mail system, and the like without additional authentication. The AI monitors an authentication state and a usage status of each system in real time, and when detecting an abnormal authentication request or an unauthorized token use, immediately locks a corresponding account and notifies an administrator of an alert. Specifically, the present generative AI processing unit dynamically generates an authentication assertion based on a security assertion markup language. The present generative AI processing unit includes an inference model that dynamically adjusts an expiration date of a token. Input data to the present inference model is a context vector including a current Internet Protocol address of a user, a security state of a device, and an access time. Output data from the present inference model is an expiration date of a token represented by a numerical value in seconds. The present generative AI processing unit sets the expiration date to 300 seconds when it is determined that a risk score is high. The present generative AI processing unit sets the expiration date to 3600 seconds when it is determined that the risk score is low. The present generative AI processing unit adds a digital signature to the generated token and transmits the token to the present terminal. The present process mathematically optimizes a trade-off between convenience and security. The present process minimizes a success probability of an unauthorized session hijacking attack. The present system reduces an authentication waiting time of a user and improves usability of the entire system.

As described above, in the embodiment of the present invention, the user information management unit, the authorization management unit, the audit record management unit, and the generative AI processing unit are centrally managed on the server side, and the user interface unit and a part of the authentication processing unit are implemented on the terminal side, whereby it is possible to comprehensively and efficiently solve problems of large-scale ID management in a telecommunications industry or an IT-related business, such as automation of account and authority management of an outsourced staff member, security risk reduction, reduction of an operation cost, elimination of personalization, accumulation of know-how, enhancement of audit response capability, efficiency improvement of inter-system cooperation, realization of single sign-on, authority control based on qualification information, and security enhancement by multi-factor authentication. The generative AI plays a core role in the entire system, such as automatic formulation of an authority assignment policy, anomaly detection, inter-system synchronization by API cooperation, analysis of an audit record, automatic notification of a risk alert, a policy review proposal, single sign-on control, and qualification information management, and becomes an indispensable element for realizing the present invention. Specifically, the present system executes asynchronous message queuing communication between respective modules. The present system adopts an ensemble learning architecture combining a plurality of artificial intelligence models. The present system performs weighted addition of inference results of the respective models to make a final determination. The present system includes an orchestration engine that dynamically optimizes allocation of computing resources. The present system automatically scales out the number of container replicas in response to a rapid increase in traffic. The present system processes millions of access requests in a globally deployed enterprise company without delay. The present system goes beyond a framework of mere business efficiency improvement and solves technical problems of traffic control of a computer network and efficiency improvement of memory management. The present system overcomes physical constraints of hardware by an advanced algorithm of software. The present system functions as a next-generation autonomous information security infrastructure.

### (System Configuration)

The system according to the present embodiment includes a user information management unit, an authorization management unit, an audit record management unit, a generative AI processing unit, a user interface unit, an authentication processing unit, and an API cooperation unit. The user information management unit centrally manages a wide variety of attribute information such as a name, an employee number, an affiliated department, a job title, an enrollment status, contact information, a business start date, a scheduled business end date, a project in charge, a system scheduled to be used, a past transfer history, a skill set, qualification information, and emergency contact information of an outsourced staff member engaged in a telecommunications industry or an IT-related business in a database. For example, in order to efficiently manage information of more than 22,000 outsourced staff members, a distributed database, a clustering technology, or a database sharding technology can be used. Furthermore, the user information management unit performs API cooperation with a human resource system or an external contract management system, receives event information such as joining, transfer, retirement, contract renewal, and contract termination in real time, and automatically updates user information. For example, when a certain staff member is assigned to a new project, the user information management unit receives an API notification from a project management system and immediately reflects information on the project in charge. Furthermore, the user information management unit can also automatically determine whether a condition necessary for a specific business or system use is satisfied based on the skill set or the qualification information of the staff member. For example, when only a staff member having an information security qualification is allowed to access a specific system, the user information management unit automatically collates the qualification information and determines whether the access is permitted or not. Specifically, the system arranges each processing unit in an independent memory address space. The user information management unit constructs a B-tree index structure in order to improve search performance of the database. The user information management unit includes a dedicated inference module that determines suitability of the qualification information. Input data to the inference module is text data of a qualification requirement requested by the system and a numerical vector indicating a qualification possessed by the user. The inference module calculates a cosine similarity between both data. Output data from the inference module is a suitability score represented by a continuous value from 0.0 to 1.0. The user information management unit writes an access permission flag to a register on a memory when the suitability score is equal to or greater than a threshold of 0.9. This process significantly reduces an execution time of a search query involving a complex conditional branch. This process enables real-time access control. The system avoids a lock contention of the database and maximizes a throughput of a transaction process.

The authorization management unit comprehensively analyzes an affiliated department, a job title, a business content, a past authority assignment record, a system usage history, project information, a skill set, qualification information, and the like of each user using generative AI, and automatically formulates a principle of least privilege policy. For example, the AI automatically determines an optimal authority set for each department, job title, and business content, such as assigning “management authority for a source code management system”, “access authority to a development environment”, and “authority to use all functions of a project management tool” to a manager of a development department, and assigning only “viewing authority for a customer information management system” and “input authority for an inquiry response system” to a staff member of a CS department. Furthermore, the AI continuously learns past authority assignment histories and access logs, automatically extracts an exception pattern such as “an additional authority is required when assigned to a specific project even with the same job title”, for example, and flexibly updates an authority assignment rule. By API cooperation from the human resource system, event information such as joining, transfer, retirement, contract renewal, and contract termination is received in real time, and an authority of a corresponding user is immediately assigned, changed, or revoked. For example, when transferring from the development department to the CS department, the AI detects a transfer event, automatically revokes the “management authority for a source code management system” assigned in the development department, and newly assigns only the “viewing authority for a customer information management system” of the CS department. At the time of retirement or contract termination, the AI automatically deletes an account of the corresponding user from all related systems and revokes all authorities. Furthermore, the AI also copes with a complex case such as “a case where the same user has an authority across a plurality of departments” or “temporary authority assignment for temporary project participation”, assigns an authority only for a necessary period, and automatically revokes the authority after the period ends. For example, an operation of temporarily assigning a system management authority for a short-term project and automatically revoking the authority after the project ends is also possible. Specifically, the authorization management unit implements an autonomous agent using a reinforcement learning algorithm. Input data to the autonomous agent is a state vector indicating a current authority set of the user and an assigned business task. The autonomous agent selects an action of adding or deleting an authority based on the state vector. Output data from the autonomous agent is an action-value matrix indicating an expected reward value of each action. The authorization management unit selects an action having a maximum value from the action-value matrix and generates an authority change command. The autonomous agent receives a positive reward upon successful task execution and receives a negative reward upon occurrence of a security incident. The autonomous agent updates a weight of an internal neural network based on a reward signal. This process realizes an autonomous adaptation capability of the system to a dynamic environmental change. This process resolves a complex authority dependency that cannot be handled by a static rule base. The system fundamentally eliminates a security vulnerability of leaving an excessive authority.

The audit record management unit records in detail all account operations (new registration, information update, deletion), authority changes (assignment, change, revocation), system access histories (login, logout, operation content), data synchronization histories with an external system by API cooperation, and terminal information (IP address, terminal identifier, used browser information, etc.) together with time information. For example, when a user is newly registered, from which terminal, which administrator assigned what kind of authority, and to which system an account was issued are recorded in detail, enabling a search and a follow-up investigation at a later date. Furthermore, the audit record management unit can also use a blockchain technology or an electronic signature technology to prevent falsification of an audit log. For example, for an important authority change or account deletion operation, multi-factor authentication of an administrator is required, and an electronic signature is added to the operation record, thereby preventing later falsification or repudiation. Furthermore, the audit record management unit also includes a periodic backup of an audit record and an archive function for long-term storage. For example, all authority change histories for the past five years are safely stored so that they can be quickly searched and extracted as necessary. Specifically, the audit record management unit implements a data compression algorithm for efficiently processing a huge amount of log data. The audit record management unit reduces a size of the log data using a dictionary-based compression method. The audit record management unit encrypts the compressed data using an advanced encryption standard algorithm. The audit record management unit executes an inter-node consensus algorithm in a distributed ledger technology. The audit record management unit synchronizes a replica of the log data among a plurality of server nodes. The audit record management unit automatically schedules data migration to an archive storage. This process significantly suppresses consumption of a physical storage capacity of a storage device. This process reduces a data transfer time over a network. The system maintains a search response performance in milliseconds for petabyte-class audit data. The system provides an improvement in computer technology that simultaneously enhances data availability and confidentiality.

The generative AI processing unit integrally analyzes diverse data such as user information, authority assignment histories, audit records, system usage statuses, and event information from an external system. The AI learns past authority assignment records, business contents, and system usage frequencies, and continuously updates an optimal authority assignment policy. The AI detects an unusual access or authority change in real time using an anomaly detection algorithm, automatically extracts an abnormal pattern such as “a user who does not usually access accesses an important system in a midnight time zone”, “the same user repeats an authority change in a plurality of systems in a short time”, or “an account of a retired user is used unauthorizedly”, for example, and performs risk notification to an administrator. The AI analyzes an authority setting error and a tendency of personalization from an operation history of an administrator and a past audit record, automatically reports a risk such as “an authority assignment error by a specific administrator occurs frequently” or “an authority setting in a specific department deviates from a standard”, and can also propose a necessity of a corrective measure or education. Furthermore, the AI also performs information synchronization with an authentication infrastructure of a cloud infrastructure or an on-premises environment through API cooperation. For example, for diverse systems such as a cloud storage service, groupware, a business application, a virtual desktop, a mail system, a file server, and a network device management system, the AI automatically analyzes an API specification and an authentication protocol of each system, and appropriately converts and synchronizes necessary authentication information and authority information. The AI monitors an authentication state and a usage status of each system in real time, and when detecting an abnormal authentication request or an unauthorized token use, immediately locks a corresponding account and notifies an administrator of an alert. The AI can also automatically control authority assignment to, for example, “a system accessible only by a staff member having a specific qualification” based on a skill set and qualification information of an outsourced staff member. Specifically, the generative AI processing unit adopts a multimodal learning architecture. Input data to the multimodal learning architecture is structured data composed of a numerical vector of a log and unstructured data composed of a text tensor of a specification. The generative AI processing unit calculates a correlation between heterogeneous data using a cross-attention mechanism. Output data from the generative AI processing unit is a data object describing an anomaly probability score and a synchronization setting. The generative AI processing unit expands an automatic blocking script on a memory and executes the automatic blocking script when the anomaly probability score exceeds a predetermined threshold. This process enables early detection of a sign of an advanced cyberattack that cannot be discovered by a single data source. This process dramatically improves a defense capability of the system against an unknown threat. The system reduces an overhead of data conversion in complex inter-system cooperation and optimizes calculation efficiency of a processor.

The user interface unit provides a screen for an outsourced staff member or an administrator to confirm his/her own account information or authority status, or to perform an application or an approval. For example, when a staff member applies for use of a new business system, application information is transmitted from a terminal to a server, and the generative AI on the server side analyzes an application content, automatically determines whether a necessary authority is appropriate, and returns feedback of approval or rejection to the terminal. The administrator can browse an audit record or a risk alert by the AI from the terminal, and instruct an additional investigation or a corrective measure as necessary. Furthermore, the user interface unit also provides an input screen for a staff member to update his/her own skill or qualification information, or to apply for a transfer or retirement. For example, when a staff member acquires a new qualification, the information is input from the terminal, and the AI can automatically assign an access authority to a corresponding system. Specifically, the user interface unit executes a differential update rendering process using a virtual document object model. The user interface unit establishes a real-time bidirectional communication session with the server using a WebSocket protocol. The generative AI processing unit on the server side includes a prediction model that assists a user's input operation. Input data to the prediction model is a text character string being input by the user. Output data from the prediction model is a text candidate list of a predicted application reason. The user interface unit suggest-displays the received text candidate list on the screen. This process avoids redrawing of the entire screen and reduces a processor load on the terminal side. This process reduces a network communication amount and saves a bandwidth. The system prevents a user's input error in advance and improves data quality.

The authentication processing unit executes identity authentication when a user or an administrator accesses the system. For example, multi-factor authentication such as password authentication, one-time password authentication, biometric authentication, and terminal authentication is combined to prevent spoofing and unauthorized access. When an administrator performs an important authority change, one-time password authentication or fingerprint authentication is requested on a terminal, and an authentication result thereof is transmitted to a server to permit an operation. Furthermore, the authentication processing unit transmits an authentication history to the audit record management unit, and records all authentication events. Specifically, the authentication processing unit implements a challenge-response authentication protocol based on a public key cryptosystem. The authentication processing unit realizes passwordless authentication. A biometric authentication module on the terminal side executes a convolutional neural network. Input data to the convolutional neural network is an image tensor of 256 pixels vertically and 256 pixels horizontally acquired from a fingerprint sensor. The convolutional neural network extracts a local feature map from the image tensor. Output data from the convolutional neural network is a continuous value score from 0.0 to 1.0 indicating a similarity with a registered template. The authentication processing unit sets an authentication success flag when the score is 0.95 or more. The authentication processing unit signs an authentication assertion using a secret key. This process completely eliminates network transmission of a password and invalidates a man-in-the-middle attack. This process reduces latency of an authentication process and improves user experience.

The API cooperation unit performs data cooperation with an external human resource system, contract management system, project management system, cloud service, on-premises system, and the like via an API. For example, joining, transfer, and retirement events from the human resource system are received in real time and reflected in the user information management unit and the authorization management unit. Authentication information and authority information are synchronized with an external system such as a cloud storage service or groupware to realize single sign-on. The API cooperation unit automatically analyzes an API specification and an authentication protocol of each system, and performs necessary data conversion and authentication processing. Specifically, the API cooperation unit adopts an asynchronous event-driven architecture using a message queuing system. The API cooperation unit implements a sequence conversion neural network for data conversion. Input data to the sequence conversion neural network is a data object described in a unique format of a transmission source system. The sequence conversion neural network encodes the input data into an intermediate representation vector. Output data from the sequence conversion neural network is a data object according to a standardized common data model. The API cooperation unit publishes the converted data to a specific topic of a message broker. This process eliminates tight coupling between systems and improves fault tolerance. This process prevents loss of a message even when a traffic spike occurs. The system maximizes a throughput of a data conversion process and ensures scalability of the entire system.

Specific examples of a prompt sentence to be read into the generative AI necessary for carrying out the present invention include “automatically extract a minimum authority set necessary for a manager of a development department from a past authority assignment history and a business content, and generate a recommended authority list”, “extract an unusual access pattern or authority change pattern from an audit record for the past one year, and list a high-risk user”, “automatically reset an authority in all systems of a corresponding user based on a transfer event received from a human resource system, and revoke an unnecessary authority”, “detect a new folder creation event of a cloud storage service, and automatically assign an access authority only to a staff member of a corresponding department”, “dynamically control an access authority to a specific system based on qualification information of a staff member”, and “analyze an audit record, extract an authority setting error and a tendency of personalization, and propose a necessity of a corrective measure or education”. By inputting these prompt sentences to the generative AI, the AI can realize a wide variety of functions such as operation optimization of the entire system, security enhancement, operation efficiency improvement, personalization elimination, know-how accumulation, and enhancement of audit response capability. Specifically, the system improves inference accuracy of a large language model using a prompt engineering technology. Input data to the system is a text sequence in which a system prompt, context data including a past log vector, and a user query are combined. The system applies a chain-of-thought prompting method to force an intermediate inference step on the model. Output data from the system is structured execution plan data defining an order and a parameter of a task to be executed. The system parses the execution plan data using an orchestration engine. The system sequentially calls an interface of each module according to the defined order. This process suppresses a hallucination phenomenon peculiar to a large language model and realizes deterministic system control. This process accurately translates an instruction in a natural language into an instruction group at a machine language level executable by a computer. The system enables highly automated operation.

### (Implementation Steps)

Step 1: Centralized registration and synchronization of user information. When an outsourced staff member newly participates, the user information management unit centrally registers detailed attribute information such as a name, an employee number, an affiliated department, a job title, an enrollment status, contact information, a business start date, a scheduled business end date, a project in charge, a system scheduled to be used, a past transfer history, a skill set, qualification information, and emergency contact information in a database. Furthermore, the user information management unit performs API cooperation with an external system such as a human resource system, a contract management system, and a project management system, receives event information such as joining, transfer, retirement, contract renewal, and contract termination in real time, and automatically synchronizes and updates the user information. For example, when new assignment information is received from the project management system, the information of the project in charge is immediately reflected. Specifically, the system receives a hypertext transfer protocol request from the external system via a webhook. Input data to the system is a payload describing details of the event. The system verifies a format of each data field in the payload using a regular expression. The system returns an error code to a transmission source when detecting a validation error. The system normalizes the successfully verified data to generate an update query for the database. Output data from the system is an update command described in a structured query language. The system issues the update command to a database engine. The system transmits an update completion event to a message broker to trigger subsequent processing. This processing prevents mixing of invalid data at the border and maintains consistency of the database. This processing eliminates a risk of business suspension due to data inconsistency between systems. The system prevents waste of human resources by automating data input.
Step 2: Automatic formulation of a principle of least privilege policy by generative AI. The authorization management unit comprehensively analyzes an affiliated department, a job title, a business content, a past authority assignment record, a system usage history, project information, a skill set, qualification information, and the like of each user utilizing generative AI, and automatically formulates a principle of least privilege policy. For example, the AI automatically determines an optimal authority set, such as assigning a management authority for a source code management system and an access authority to a development environment to a manager of a development department, and assigning only a viewing authority for a customer information management system to a staff member of a CS department. Specific examples of a prompt sentence to be read by the generative AI include “automatically extract a minimum authority set necessary for a manager of a development department from a past authority assignment history and a business content, and generate a recommended authority list”, “extract only necessary authorities from a business content and a past usage history of a CS department staff member, and formulate a principle of least privilege policy”, and the like. Specifically, the authorization management unit executes a deep neural network equipped with an attention mechanism. Input data to the deep neural network is a tensor combining a 512-dimensional user attribute vector and a system requirement matrix. The deep neural network performs a weighting calculation on a dependency relationship between each element in the tensor. Output data from the deep neural network is a one-dimensional array storing a probability score indicating the necessity of each authority. The authorization management unit extracts an authority having a probability score of 0.9 or more. The authorization management unit dynamically generates a definition file of an access control list based on the extracted authority set. The authorization management unit deploys the generated definition file to each target system. This processing completely eliminates human errors caused by manual setting. This processing strictly and automatically applies the principle of least privilege. The system facilitates compliance proof in a security audit and dramatically reduces an operation cost.
Step 3: Automatic assignment, change, and revocation of an authority by an event trigger. By API cooperation from a human resource system or a contract management system, event information such as joining, transfer, retirement, contract renewal, and contract termination is received in real time, and an authority of a corresponding user is immediately assigned, changed, or revoked. For example, in the case of a transfer from a development department to a CS department, the AI detects a transfer event, automatically revokes the authority assigned in the development department, and newly assigns only the authority of the CS department. At the time of retirement or contract termination, the AI automatically deletes the account of the corresponding user from all related systems and revokes all authorities. Specific examples of a prompt sentence to be read by the generative AI include “automatically reset authorities in all systems of a corresponding user based on a transfer event received from a human resource system, and revoke an unnecessary authority”, “when detecting a retirement event, delete an account from all related systems and leave an audit record”, and the like. Specifically, the system adopts an event-driven architecture. The system includes a parallel computing cluster using an image processing semiconductor. The API cooperation unit receives an event payload in a JSON format from an external system. The processing unit parses event data. The processing unit tokenizes text data. The processing unit removes unnecessary symbols. The generative AI processing unit implements a large language model having billions of parameters. The model has a structure in which a plurality of transformer layers are stacked. The model calculates a dependency relationship between tokens using a self-attention mechanism. The generative AI processing unit receives a multidimensional word embedding tensor as input data. The input data includes, for example, a vector representation of a text “the affiliation of user A has been changed from the development department to the CS department”. The input data includes, for example, a vector representation of a text “the contract of user B has been terminated”. The input data includes, for example, a vector representation of a text “user C has been assigned to a new project”. The generative AI processing unit generates structured data of an authority change instruction as output data. The output data includes, for example, a key-value pair of “access authority of system X: delete”. The output data includes, for example, a key-value pair of “access authority of system Y: add”. The output data includes, for example, a key-value pair of “account state of system Z: invalidate”. The authorization management unit analyzes the output structured data. The authorization management unit issues an authority change command to an access control interface of each target system. The authorization management unit transmits an execution result of the command to the audit record management unit. The model is pre-trained using a past authority change history. The learning process updates weights so as to minimize a cross-entropy error function. The learning process uses a gradient descent algorithm. This configuration enables immediate reflection of an authority without manual intervention by an administrator. This configuration completely prevents omission of revocation of an authority. This configuration brings about a technical effect of significantly reducing a security risk of information leakage. This configuration improves a processing throughput of the entire system. This technology can be applied as an integrated ID management infrastructure in a multinational corporation having tens of thousands of employees. This technology can be applied to an access management system of a financial institution where organizational changes frequently occur. The system dynamically interprets a complex business rule by a vector operation in a high-dimensional space. The system provides flexibility surpassing conventional static rule-based processing.
Step 4: Detailed collection and falsification prevention of audit records. The audit record management unit records in detail all account operations (new registration, information update, deletion), authority changes (assignment, change, revocation), system access histories (login, logout, operation content), data synchronization histories with an external system by API cooperation, and terminal information (IP address, terminal identifier, used browser information, etc.) together with time information. For an important authority change or account deletion operation, multi-factor authentication of an administrator is required, and a digital signature is added to the operation record, thereby preventing subsequent falsification or repudiation. The audit records are periodically backed up, and an archive function for long-term storage is also provided. Specifically, the audit record management unit has an advanced data processing infrastructure that cooperates with a distributed ledger technology. The system includes a plurality of storage nodes connected by a high-speed internal bus. The audit record management unit analyzes a log in cooperation with the generative AI processing unit. The processing unit normalizes raw log data. The processing unit unifies a time stamp to coordinated universal time. The generative AI processing unit implements a natural language processing model. The generative AI processing unit receives a time-series array of audit logs as input data. The input data includes, for example, a numerical vector of a login time. The input data includes, for example, a character string vector of an access destination IP address. The input data includes, for example, a text vector of an operation command. The generative AI processing unit generates a summary text of the log and a risk score as output data. The output data includes, for example, a floating-point number of a risk score of 0.95. The output data includes, for example, a warning label indicating that a possibility of unauthorized access is high. The output data includes, for example, a flag recommending forced disconnection of a corresponding session. The audit record management unit compares the output risk score with a threshold value. The audit record management unit transmits an immediate alert to the administrator when the score exceeds the threshold value. The audit record management unit applies a hash function to all log data. The audit record management unit records the generated hash value in a blockchain network. By this processing, the integrity of the log is mathematically proven. The model uses a normal log pattern as learning data. The learning process adopts a self-supervised learning method. The learning process optimizes weights of a network so as to minimize a reconstruction error. This configuration instantaneously identifies a minute abnormality that is difficult to find with human eyes from a huge amount of log data. This configuration brings about a technical effect of dramatically reducing a load of an audit business. This configuration realizes data management that strictly satisfies a compliance requirement. This technology can be applied to an electronic medical record system of a medical institution where a strict audit is required. This technology can be applied to a confidential information management system of a government agency. The system executes active semantic analysis of a log beyond mere data storage. The system provides advanced security monitoring different from a conventional simple character string search.
Step 5: Anomaly detection and risk alert by generative AI. The generative AI processing unit integrally analyzes diverse data such as user information, authority assignment histories, audit records, system usage statuses, and event information from an external system, and detects an unusual access or authority change in real time using an anomaly detection algorithm. For example, when a user who does not usually access in a midnight time zone accesses an important system, when the same user repeats authority changes in a plurality of systems in a short time, or when an account of a retired user is illegally used, an abnormal pattern is automatically extracted, and a risk notification is sent to an administrator. Specific examples of a prompt sentence to be read by the generative AI include “extract an unusual access pattern or authority change pattern from audit records of the past one year, and list high-risk users”, “when an abnormal authority change or access occurs, immediately notify an administrator of an alert”, and the like. Specifically, the generative AI processing unit adopts an autoencoder architecture based on a long short-term memory network. The system includes a tensor operation unit specialized for processing time-series data. The processing unit maps diverse log data to the same dimensional space. The processing unit performs one-hot encoding on categorical data. The processing unit standardizes a continuous value so as to have a zero mean and a unit variance. The generative AI processing unit receives a time-series access log tensor as input data. The input data includes, for example, a binary flag indicating an access at 2:00 midnight. The input data includes, for example, numerical data of the number of login attempts from an unusual IP address. The input data includes, for example, count data of the number of authority changes in a short time. The generative AI processing unit generates an anomaly score based on a reconstruction error as output data. The output data includes, for example, a floating-point number of an anomaly score of 0.88. The output data includes, for example, a vector indicating a contribution degree of an IP address as an anomaly factor. The output data includes, for example, an account lock instruction as a recommended response action. The processing unit determines whether the output anomaly score exceeds a preset dynamic threshold value. The processing unit immediately invalidates a session token of a corresponding account when detecting the excess. The processing unit simultaneously displays a warning on a dashboard of a security operation team. The model is learned using only a past normal access history. The learning process uses a backpropagation through time algorithm. The learning process uses a mean square error as a loss function. This configuration blocks an unknown cyberattack or internal fraud in real time. This configuration brings about a technical effect of preventing expansion of damage. This configuration reduces a false positive rate and reduces fatigue of an operation person in charge. This technology can be applied to a countermeasure against unauthorized login of a large-scale e-commerce platform. This technology can be applied to an infrastructure monitoring system of a cloud service provider. The system executes dynamic behavior-based detection instead of static signature-based detection. The system realizes objective and highly accurate risk evaluation that does not depend on human intuition.
Step 6: Inter-system synchronization and single sign-on by API cooperation. The API cooperation unit performs data cooperation with an external human resource system, contract management system, project management system, cloud service, on-premises system, and the like via an API. The API cooperation unit synchronizes authentication information and authority information with an external system such as a cloud storage service and groupware, and realizes single sign-on. The AI automatically analyzes an API specification and an authentication protocol of each system, and performs necessary data conversion and authentication processing. For example, when a new folder is created in a cloud storage service, the AI detects the event and automatically assigns an access authority only to a staff member of a corresponding department. Specific examples of a prompt sentence to be read by the generative AI include “detect a new folder creation event of a cloud storage service, and automatically assign an access authority only to a staff member of a corresponding department”, “monitor an authentication state and a usage status of each system in real time, and when detecting an abnormal authentication request or an unauthorized token use, immediately lock a corresponding account and notify an administrator of an alert”, and the like. Specifically, the API cooperation unit implements a dependency relationship analysis engine using a graph neural network. The system controls communication between systems using an asynchronous message queuing protocol. The processing unit converts data acquired from each system into a common data model. The processing unit complements a missing value of data. The generative AI processing unit receives dependency relationship graph data between systems as input data. The input data includes, for example, an edge weight indicating a cooperation frequency between system A and system B. The input data includes, for example, a node feature amount indicating an affiliated department of a user. The input data includes, for example, time-series numerical data indicating a past authentication success rate. The generative AI processing unit generates an optimal synchronization timing and a necessary authority set as output data. The output data includes, for example, a time stamp indicating a recommended time of synchronization execution. The output data includes, for example, a list of minimum authorities to be assigned. The output data includes, for example, a deletion flag of an unnecessary authority. The API cooperation unit automatically generates an API request to each external system based on the output authority set. The API cooperation unit transmits the generated requests in an appropriate order. The API cooperation unit monitors a response code from each system. The model learns a communication log between systems as a graph structure. The learning process simultaneously optimizes a node classification task and a link prediction task. The learning process updates weights of a graph convolutional network. This configuration automatically resolves an authority inconsistency between a plurality of complexly intertwined systems. This configuration brings about a technical effect of dramatically lowering an introduction barrier of single sign-on. This configuration optimizes network traffic and minimizes a communication delay. This technology can be applied to an IT environment of a modern company using a large number of SaaS applications. This technology can be applied to a system integration project accompanying a corporate merger or acquisition. The system executes semantic data conversion and synchronization instead of a mere copy of data. The system autonomously controls inter-system cooperation on a scale that cannot be manually set and managed by a human.
Step 7: Application, approval, and information update by a user interface. The user interface unit provides a screen for an outsourced staff member or an administrator to confirm his/her own account information and authority status, and to perform an application and an approval. When a staff member applies for use of a new business system, application information is transmitted from a terminal to a server, and the generative AI on the server side analyzes an application content, automatically determines whether a necessary authority is appropriate, and returns feedback of approval or rejection to the terminal. When a staff member updates his/her own skill or qualification information, the information is input from the terminal, and the AI automatically assigns an access authority to a corresponding system. The administrator can browse an audit record and a risk alert by the AI from the terminal, and instruct an additional investigation or a corrective measure as necessary. Specifically, the user interface unit functions as an interactive agent incorporating a natural language processing model. The system includes an edge cache mechanism that optimizes rendering of a front end. The processing unit normalizes a natural language text input by a user. The processing unit removes a stop word from the text. The generative AI processing unit implements a bidirectional encoder representations model. The generative AI processing unit receives a word embedding vector of an application text of a user as input data. The input data includes, for example, an authority request text for participation in a new project. The input data includes, for example, character string data of a system name desired to be added. The input data includes, for example, numerical data indicating a usage period. The generative AI processing unit generates a validity score of the application and an automatic approval flag as output data. The output data includes, for example, a floating-point number of a validity score of 0.92. The output data includes, for example, a boolean value indicating whether automatic approval is possible or not. The output data includes, for example, a pointing-out text of missing information. The user interface unit dynamically changes a display content of the screen based on the output validity score. The user interface unit delegates processing to the authorization management unit when the automatic approval flag is true. The user interface unit presents an additional input prompt to the user when there is missing information. The model is fine-tuned using history data of past applications and approvals. The learning process adjusts an attention weight so as to minimize a classification error. The learning process uses an Adam optimizer. This configuration significantly reduces a time required for an approval work of an administrator. This configuration brings about a technical effect of minimizing a waiting time of a user and improving business efficiency. This configuration eliminates ambiguity of an application content and realizes accurate authority assignment. This technology can be applied to a large-scale development center where thousands of authority applications occur daily. This technology can be applied to asynchronous business process management under a remote work environment. The system accurately understands an intention of a free description as well as a routine form input. The system reproduces a flexible judgment considering a context, which is performed by a human administrator, on a computer.
Step 8: Security enhancement by authentication processing. The authentication processing unit executes identity authentication when a user or an administrator accesses a system. By combining multi-factor authentication such as password authentication, one-time password authentication, biometric authentication, and terminal authentication, spoofing and unauthorized access are prevented. When an administrator performs an important authority change, one-time password authentication or fingerprint authentication is requested on a terminal, and an authentication result thereof is transmitted to a server to permit an operation. An authentication history is transmitted to the audit record management unit, and all authentication events are recorded. Specifically, the authentication processing unit implements a biometric information analysis engine using a convolutional neural network. The system includes a lightweight neural network for performing inference on an edge device side. The processing unit preprocesses biometric information acquired from a camera or a sensor. The processing unit removes noise of an image. The processing unit adjusts contrast. The authentication processing unit receives an image tensor of biometric information as input data. The input data includes, for example, an RGB pixel value array of a face image. The input data includes, for example, a binarized image of a ridge pattern of a fingerprint. The input data includes, for example, infrared image data of a vein pattern. The authentication processing unit generates a similarity score with registered data as output data. The output data includes, for example, a floating-point number of a cosine similarity of 0.99. The output data includes, for example, a boolean value indicating authentication success. The output data includes, for example, a floating-point number indicating a spoofing probability. The authentication processing unit issues a session token only when the output similarity score exceeds a strict threshold value. The authentication processing unit requests an additional authentication element when determining that the spoofing probability is high. The authentication processing unit temporarily locks an account when authentication failures continue. The model is pre-trained using a biometric information dataset of millions of people. The learning process brings feature vectors of the same person closer using a triplet loss function. The learning process updates weights so as to distance feature vectors of different persons. This configuration makes unauthorized access due to leakage or theft of a password physically impossible. This configuration brings about a technical effect of not impairing user convenience while maintaining an extremely high security level. This configuration shortens a latency of authentication processing to a millisecond unit. This technology can be applied to access control of a research and development department handling highly confidential information. This technology can be applied to privileged access management to a core system of a financial institution. The system performs identity verification by distance calculation in a high-dimensional feature space instead of mere pattern matching. The system realizes robust authentication even against secular change and fluctuation of environmental light.

### (Specific Use Case)

For example, in a telecommunications industry or an IT-related business, when an outsourced staff member newly participates in a large-scale project, the user information management unit centrally registers detailed attribute information such as a name, an employee number, an affiliated department, a job title, an enrollment status, contact information, a business start date, a scheduled business end date, a project in charge, a system scheduled to be used, a past transfer history, a skill set, qualification information, and emergency contact information of the staff member in a database. The user information management unit performs API cooperation with an external system such as a human resource system, a contract management system, and a project management system, receives event information such as joining, transfer, retirement, contract renewal, and contract termination in real time, and automatically synchronizes and updates the user information. For example, when new assignment information is received from the project management system, the information of the project in charge is immediately reflected. The authorization management unit comprehensively analyzes an affiliated department, a job title, a business content, a past authority assignment record, a system usage history, project information, a skill set, qualification information, and the like of the staff member using generative AI, and automatically formulates a principle of least privilege policy. For example, the AI automatically determines an optimal authority set, such as assigning a management authority for a source code management system, an access authority to a development environment, and an authority to use all functions of a project management tool to a manager of a development department, and assigning only a viewing authority for a customer information management system and an input authority for an inquiry response system to a staff member of a CS department. Furthermore, the AI continuously learns a past authority assignment history and an access log, automatically extracts an exception pattern in which an additional authority is required when assigned to a specific project even with the same job title, and flexibly updates an authority assignment rule. By API cooperation from the human resource system, event information such as joining, transfer, retirement, contract renewal, and contract termination is received in real time, and an authority of a corresponding user is immediately assigned, changed, or revoked. For example, in the case of a transfer from the development department to the CS department, the AI detects a transfer event, automatically revokes the authority assigned in the development department, and newly assigns only the authority of the CS department. At the time of retirement or contract termination, the AI automatically deletes the account of the corresponding user from all related systems and revokes all authorities. The audit record management unit records in detail all account operations, authority changes, system access histories, data synchronization histories with an external system by API cooperation, and terminal information together with time information. For an important authority change or account deletion operation, multi-factor authentication of an administrator is required, and a digital signature is added to the operation record, thereby preventing subsequent falsification or repudiation. The audit records are periodically backed up, and an archive function for long-term storage is also provided. The generative AI processing unit integrally analyzes diverse data such as user information, authority assignment histories, audit records, system usage statuses, and event information from an external system, and detects an unusual access or authority change in real time using an anomaly detection algorithm. For example, when a user who does not usually access in a midnight time zone accesses an important system, when the same user repeats authority changes in a plurality of systems in a short time, or when an account of a retired user is illegally used, an abnormal pattern is automatically extracted, and a risk notification is sent to an administrator. The API cooperation unit performs data cooperation with an external human resource system, contract management system, project management system, cloud service, on-premises system, and the like via an API, synchronizes authentication information and authority information with an external system such as a cloud storage service and groupware, and realizes single sign-on. The AI automatically analyzes an API specification and an authentication protocol of each system, and performs necessary data conversion and authentication processing. For example, when a new folder is created in a cloud storage service, the AI detects the event and automatically assigns an access authority only to a staff member of a corresponding department. The user interface unit provides a screen for an outsourced staff member or an administrator to confirm his/her own account information and authority status, and to perform an application and an approval, and when a staff member applies for use of a new business system, application information is transmitted from a terminal to a server, and the generative AI on the server side analyzes an application content, automatically determines whether a necessary authority is appropriate, and returns feedback of approval or rejection to the terminal. The authentication processing unit executes identity authentication when a user or an administrator accesses a system, and prevents spoofing and unauthorized access by combining multi-factor authentication such as password authentication, one-time password authentication, biometric authentication, and terminal authentication. When an administrator performs an important authority change, one-time password authentication or fingerprint authentication is requested on a terminal, and an authentication result thereof is transmitted to a server to permit an operation. An authentication history is transmitted to the audit record management unit, and all authentication events are recorded. Specifically, the entire system is integrally controlled by a multi-agent reinforcement learning architecture. The system includes a distributed database and a real-time stream processing engine. The processing unit processes data continuously flowing from each subsystem in-memory. The processing unit performs sharding of data to distribute a load. The generative AI processing unit receives an environmental state vector as input data. The input data includes, for example, numerical data indicating a current load status of all systems. The input data includes, for example, count data of the total number of accesses of users. The input data includes, for example, an integer value of the number of security alerts occurring. The generative AI processing unit generates an optimal resource allocation and authority control policy as output data. The output data includes, for example, a categorical value indicating an access restriction level to a specific system. The output data includes, for example, a flag for raising a monitoring level. The output data includes, for example, an instruction to extend a storage period of an audit log. The system immediately applies the output policy to each subsystem. The system dynamically changes allocation of a network bandwidth. The system automatically blocks a specific communication port when an abnormality occurs. The model is learned through millions of episodes in a simulation environment. The learning process updates an action value function of each agent so as to maximize a reward function. The learning process performs optimization based on a Markov decision process. This configuration achieves overall optimization that is impossible with individual system management. This configuration brings about a technical effect of guaranteeing stable operation of the system even when a large-scale organizational change or a cyberattack occurs. This configuration maximizes a security level while dramatically reducing an operation cost. This technology can be applied to a core system of a global telecommunications carrier having tens of thousands of servers and hundreds of thousands of users. This technology can be applied to integrated management of a large-scale data center having a mission-critical requirement. The system autonomously controls a complex inter-system interaction exceeding human cognitive limits. The system provides an innovative approach that fundamentally overturns a conventional siloed system management method.

Specific examples of prompt sentences to be read by the generative AI include “automatically extract a minimum authority set necessary for a manager of a development department from past authority assignment histories and business contents, and generate a recommended authority list”, “extract only necessary authorities from business contents and past usage histories of a CS department staff member, and formulate a principle of least privilege policy”, “automatically reset authorities in all systems of a corresponding user based on a transfer event received from a human resource system, and revoke an unnecessary authority”, “when a retirement event is detected, delete an account from all related systems, and leave an audit record”, “extract an unusual access pattern or authority change pattern from audit records of the past one year, and list high-risk users”, “detect a new folder creation event of a cloud storage service, and automatically assign an access authority only to a staff member of a corresponding department”, “monitor an authentication state and a usage status of each system in real time, and when an abnormal authentication request or unauthorized token usage is detected, immediately lock a corresponding account and notify an administrator of an alert”, “analyze audit records, extract an authority setting error and a tendency of personalization, and propose a corrective measure and a necessity of education”, and the like. Specifically, the generative AI processing unit implements a meta-learning model that automatically optimizes prompt engineering. The system includes a large-capacity memory for processing a large-scale context window. The processing unit parses an input initial prompt. The processing unit extracts a purpose and a constraint condition of a task. The meta-learning model receives a text vector of a task description as input data. The input data includes, for example, an embedding vector of an instruction sentence of an authority extraction task. The input data includes, for example, history data of a past successful prompt. The input data includes, for example, a vector representation of a specification text of a target system. The meta-learning model generates an optimized prompt character string as output data. The output data includes, for example, a detailed instruction sentence with reinforced context. The output data includes, for example, a strict designation sentence of an output format. The output data includes, for example, a chain-of-thought prompt for clarifying an inference process. The generative AI processing unit transmits an inference request to a main language model using the generated optimized prompt. The generative AI processing unit verifies an output from the main model. The generative AI processing unit regenerates the prompt and retries when the output does not satisfy a requirement. The meta-learning model learns a characteristic of the task from a small number of samples using a few-shot learning method. The learning process performs reinforcement learning using a reward model that evaluates effectiveness of the prompt. The learning process updates a parameter of a prompt generator using a policy gradient method. This configuration completely eliminates time and effort for a human to manually adjust the prompt. This configuration brings about a technical effect of dramatically improving output accuracy and stability of the AI. This configuration makes it possible to always draw an optimal inference result even for a complex business requirement. This technology can be applied to an automation infrastructure in an enterprise environment in which a wide variety of business systems coexist. This technology can be applied to an interface that allows even a user without specialized knowledge to utilize an advanced AI function. The system dynamically constructs an instruction by understanding semantics of the task instead of a mere character string template. The system realizes an advanced self-optimization loop in which the AI itself controls the AI.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

As an embodiment for carrying out the present invention, a system configuration that integrally and dynamically automates physical and logical access authority management in a data center is adopted. The system includes a user information management unit, an authorization management unit, an audit record management unit, a generative AI processing unit, an API cooperation unit, a user interface unit, and an authentication processing unit, and each unit operates in a shared manner on a server or a terminal. Specifically, the system adopts a hybrid architecture in which edge computing and cloud computing are fused. The system is connected to an IoT sensor group arranged at various places in the data center via a high-speed network. The processing unit receives streaming data continuously transmitted from each sensor. The processing unit executes noise filtering of the data. The generative AI processing unit receives a time-series array of sensor data as input data. The input data includes, for example, numerical data of a temperature sensor in a server room. The input data includes, for example, a moving object detection flag of a monitoring camera. The input data includes, for example, a time stamp of an opening/closing history of an entry/exit gate. The generative AI processing unit generates a comprehensive security state score of the data center as output data. The output data includes, for example, a floating-point number of a comprehensive security score of 0.85. The output data includes, for example, an integer value indicating an alert level. The output data includes, for example, three-dimensional coordinate data of an abnormality occurrence area. The system issues a control command for each facility based on the output score. The system controls air conditioning in a corresponding area when an abnormality is detected. The system blinks lighting and transmits a notification to a security guard when a suspicious person is detected. The model is pre-trained by an autoencoder using environmental data in a normal state. The learning process optimizes a weight of a network so as to minimize a reconstruction error of the input data. The learning process performs representation learning of a latent space. This configuration eliminates a boundary between a physical space and a logical space, and realizes comprehensive security monitoring. This configuration brings about a technical effect of dramatically improving a response speed when an incident occurs. This configuration maximizes operational efficiency of the data center and minimizes downtime. This technology can be applied to a mainframe operation center of a financial institution that requires extremely high availability. This technology can be applied to physical security management of a government-affiliated data center that handles national secrets. The system interprets a dynamic change in a physical environment in real time instead of mere log aggregation. The system provides flexibility in which each functional module scales independently by a microservice architecture.

The user information management unit centrally manages a wide variety of attribute information such as a name, an ID, a role, an affiliated company, an enrollment status (enrolled, retired, visitor, contract ended, etc.), contact information, shift information, an area in charge, a past entry/exit history, qualification information, emergency contact information, a health condition, a work schedule, a facility in charge, an access history, and an entry/exit gate usage history of all users who enter and exit the data center, that is, an operation engineer, a maintenance worker, an outsourced contractor, a security personnel, a cleaning staff member, an equipment inspector, a temporary worker, an auditor, and the like in a database. For example, when an outsourced contractor needs to enter the server room only for a specific period, the period, the area in charge, a work content, a scheduled work time, a person in charge of work, a necessary qualification, presence/absence of a work procedure manual, and emergency contact information can be registered in detail. For example, when an equipment inspector temporarily enters the data center for an annual inspection, a scheduled inspection date, an area in charge, a necessary equipment list, an inspection content, a submission deadline of an inspection result report, and the like can also be recorded. For example, when a cleaning staff member enters a specific area on a fixed day of the week and time zone every week, it can be registered in the shift information as a regular schedule and managed in association with the entry/exit history. For example, when a temporary worker temporarily enters for an emergency response, an emergency response reason, a response content, a response start/end time, a person in charge of the response, a reporting obligation after the response, and the like can also be recorded. Specifically, the user information management unit models a complex relationship using a graph database. The system holds a relationship graph by nodes and edges in memory. The processing unit maps diverse attribute information of the user to a multidimensional vector space. The processing unit digitizes text information by a word embedding technology. The generative AI processing unit implements a feature amount extraction model using an autoencoder. The generative AI processing unit receives a multidimensional vector of a user attribute as input data. The input data includes, for example, continuous value data of an age and years of service. The input data includes, for example, categorical data of a possessed qualification. The input data includes, for example, count data of the number of past entries/exits. The generative AI processing unit generates a latent representation vector of the user as output data. The output data includes, for example, a 64-dimensional latent feature vector. The output data includes, for example, a group ID for clustering. The output data includes, for example, a list of similar users. The user information management unit calculates an initial assignment of an access authority using the output latent vector. The user information management unit presents a recommended setting with reference to an authority setting of a similar user. The user information management unit recalculates the latent vector when detecting a change in the attribute information. The model is trained by unsupervised learning using user data of tens of thousands of people. The learning process minimizes an error between an input vector and an output vector. The learning process optimizes a data distribution in the latent space. This configuration manages a user group having a wide variety of employment forms and roles based on a unified standard. This configuration brings about a technical effect of completely eliminating a manual attribute input error and a setting omission. This configuration dramatically improves a search speed of the database. This technology can be applied to an entry/exit management system of a large-scale manufacturing plant where thousands of people enter and exit. This technology can be applied to a worker management system at a construction site involving a large number of external vendors. The system analyzes a semantic connection of data beyond a framework of a mere relational database. The system realizes intuitive grouping and authority management by similarity calculation in a high-dimensional space.

The authorization management unit comprehensively analyzes a role, an affiliated company, a business content, a work schedule, qualification information, a past access record, shift information, an area in charge, a health condition, a person in charge of work, a work content, an emergency response history, and the like of each user using generative AI, and automatically assigns a minimum and optimal logical access authority (e.g., server management, network setting, monitoring system operation, equipment management system operation, log browsing, setting change, failure response authority, etc.) and physical access authority (e.g., server room, power supply room, monitoring room, storage area, air conditioning equipment room, electrical equipment room, network equipment room, common space, break room, etc.). For example, an entry authority to the server room and the monitoring room and an operation authority of a server management system are assigned to the operation engineer, an entry authority to the server room and a temporary setting change authority only during a work period are assigned to the outsourced contractor, an entry authority to all areas and all authorities of a monitoring system are assigned to the security personnel, a physical access authority limited only to a cleaning area is assigned to the cleaning staff member, only a physical access authority to a scheduled inspection area and a browsing authority of an equipment management system are assigned to the equipment inspector, and an entry authority to all areas and a log browsing authority only during an audit period are assigned to the auditor. For example, the AI learns a past access history and an abnormality detection history, immediately detects an unusual behavior such as “when an outsourced contractor attempts to enter a power supply room that is not normally accessed”, “when an operation engineer attempts to enter a server room in a midnight time zone”, “when a cleaning staff member attempts to enter an area out of charge”, “when an equipment inspector attempts to enter an unscheduled inspection area”, and “when a temporary worker stays for a long time even after an end of an emergency response”, and notifies an administrator of an alert. For example, based on the qualification information, it is also possible to assign an access authority to a specific area or system only to a user having a specific advanced security qualification. For example, when it is determined that the health condition is poor, the physical access authority can be temporarily suspended and the administrator can be notified. For example, when the person in charge of work is absent, the access authority of a worker can also be temporarily restricted. Specifically, the authorization management unit implements an ensemble learning model combining a decision tree and a neural network. The system is connected to a control device of a physical gate via a low-latency network. The processing unit combines a static attribute of the user and dynamic environmental information. The processing unit normalizes the combined data to generate a feature vector. The generative AI processing unit receives a combined vector of a user feature and an environmental feature as input data. The input data includes, for example, a latent representation vector of the user. The input data includes, for example, current time data. The input data includes, for example, an importance score of a target area. The generative AI processing unit generates an access permission probability as output data. The output data includes, for example, a floating-point number of a permission probability of 0.95. The output data includes, for example, a list of authorities to be assigned. The output data includes, for example, numerical data indicating an accessible time. The authorization management unit transmits an unlocking command to a gate control system when the output permission probability exceeds a threshold value. The authorization management unit activates an additional approval process when the permission probability is low. The authorization management unit immediately suspends all authorities when receiving a flag indicating deterioration of the health condition. The model is subjected to supervised learning using a past access approval history and an incident record. The learning process updates a weight of each model so as to minimize a cross-entropy error. The learning process uses a gradient boosting algorithm. This configuration completely synchronizes physical access and logical access. This configuration brings about a technical effect of strictly applying the principle of least privilege and minimizing an internal threat. This configuration realizes dynamic control of revoking an authority in real time according to a change in a situation. This technology can be applied to entry/exit management of a laboratory with a high biosafety level. This technology can be applied to strict access control in an important facility of a nuclear power plant. The system makes a determination by understanding a context without depending on a static access control list. The system simultaneously processes thousands of access requests with a speed and accuracy impossible for a human security guard.

The audit record management unit records in detail all account operations (new registration, information update, deletion), authority changes (assignment, change, revocation), physical entry/exit records (entry/exit gate passage time, gate ID, entry/exit reason, accompanying person information, video record at the time of entry/exit, etc.), logical system access records (login, logout, operation content, operation terminal information, operation time, operation target system, detail of operation content, operation result, error occurrence history, etc.), data synchronization histories with an external system by API cooperation, and terminal information (ID of entry/exit gate, IP address of used terminal, terminal identifier, used browser information, security state of terminal, etc.) of all users together with time information. For example, when an operation engineer enters a server room, logs in to a server management system, changes a setting, and executes a failure response, a series of physical/logical accesses and operation histories thereof are recorded in chronological order. For example, when an outsourced contractor attempts to enter a room outside a work period, an attempt record and an authentication failure history at a gate are also left in detail. For example, when an equipment inspector submits an inspection result report after an inspection work, a submission history thereof is also stored as an audit record. For an important authority change or account deletion operation, multi-factor authentication of an administrator is required, and an electronic signature is added to an operation record thereof, thereby preventing subsequent falsification or repudiation. The audit records are periodically backed up, and an archive function for long-term storage is also provided. For example, all authority change histories, entry/exit histories, operation histories, and abnormality detection histories for the past five years are safely stored, and can be quickly searched and extracted as necessary. Specifically, the audit record management unit adopts an architecture in which a time-series database and a natural language generation model are integrated. The system includes a distributed storage cluster for processing petabyte-class data. The processing unit parses log data in a wide variety of formats. The processing unit converts the data into a structured JSON format. The generative AI processing unit receives a tensor of structured log data as input data. The input data includes, for example, a time stamp of an operation date and time. The input data includes, for example, an ID number of an operator. The input data includes, for example, character string data of an executed command. The generative AI processing unit generates a human-readable audit report text as output data. The output data includes, for example, a text of a daily security summary. The output data includes, for example, a highlight sentence of an abnormal operation. The output data includes, for example, a text of a recommended improvement measure. The audit record management unit converts the output report into a PDF and automatically transmits the PDF to the administrator. The audit record management unit executes hash calculation using a Merkle tree for all log data. The audit record management unit periodically writes a root hash to an external public blockchain. The model is fine-tuned using a pair of a past audit report and raw log data. The learning process maximizes a BLEU score between the generated text and a correct text. The learning process optimizes a weight of a decoder layer of a transformer. This configuration converts a huge amount of dry log data into meaningful intelligence. This configuration brings about a technical effect of dramatically reducing man-hours required for an audit response from several weeks to several minutes. This configuration makes data falsification mathematically impossible and ensures evidence capability. This technology can be applied to an accounting system of a bank subject to a strict audit by the Financial Services Agency. This technology can be applied to a trail management system for complying with an internal control reporting system of a listed company. The system functions as an intelligent auditor that autonomously generates a report instead of a mere data storage device. The system minimizes a long-term storage cost by a data compression algorithm and hierarchical storage management.

The generative AI processing unit integrally analyzes diverse data such as user information, authority assignment histories, audit records, system usage statuses, event information from an external system, a health condition, a work schedule, an emergency response history, an equipment inspection history, and a cleaning history, and detects an unusual access or authority change in real time using an anomaly detection algorithm. For example, the generative AI processing unit automatically extracts an abnormal pattern such as when a user who does not normally access enters an important area in a midnight time zone, when an outsourced contractor attempts to enter a power supply room, when an account of a retired user is illegally used, when a cleaning staff member enters an area out of charge, when an equipment inspector enters an unscheduled inspection area, or when a temporary worker stays for a long time even after an end of an emergency response, and performs risk notification to an administrator. For example, the generative AI processing unit can analyze an authority setting error and a tendency of personalization from an operation history of an administrator and a past audit record, automatically report a risk such as “an authority assignment error by a specific administrator frequently occurs”, “suspicious accesses frequently occur by a specific outsourced contractor”, or “abnormal accesses are concentrated in a specific area”, and propose a corrective measure and a necessity of education. For example, the AI can analyze a history of user movement and authority transfer between a plurality of data center bases, and automatically evaluate and adjust consistency of a security policy between the bases. For example, the AI can analyze an equipment inspection history and a cleaning history, detect an omission of work or an unauthorized work execution, and report it to the administrator. Specifically, the generative AI processing unit implements a multimodal transformer architecture. The system includes a dedicated GPU cluster for simultaneously processing video data and text data. The processing unit extracts a video stream from a monitoring camera in units of frames. The processing unit converts a text log into a word embedding vector. The generative AI processing unit receives a combined tensor of video data and a text log as input data. The input data includes, for example, a frame image array of a monitoring camera. The input data includes, for example, an authentication log text of an entry/exit gate. The input data includes, for example, time-series numerical data of an environmental sensor. The generative AI processing unit generates a comprehensive risk evaluation result as output data. The output data includes, for example, a category value indicating a level of a risk level. The output data includes, for example, a start time and an end time of an abnormal behavior. The output data includes, for example, bounding box coordinates of a suspicious person. The generative AI processing unit immediately activates an alarm system when the output risk level reaches a maximum value. The generative AI processing unit forcibly locks an electronic lock in a corresponding area. The generative AI processing unit saves related recorded data to an overwrite-prohibited area. The model is subjected to self-supervised learning using a pair of a video of a normal business scene and a log. The learning process brings latent representations of a video and a text closer to each other using contrastive learning. The learning process optimizes a decision boundary for anomaly detection. This configuration directly detects a physical abnormal behavior that cannot be seen through only by a text log from a video. This configuration brings about a technical effect of dramatically reducing a false alarm by multiplying a plurality of data sources. This configuration automatically levels a variation in a security level between bases. This technology can be applied to an integrated security operation center of a global company spanning a plurality of countries. This technology can be applied to a remote monitoring system of an unmanned smart factory. The system completely replaces a conventional operation in which a human monitoring staff member watches a plurality of monitors. The system mathematically executes an intuitive risk evaluation by a multimodal operation in a high-dimensional space.

The API cooperation unit performs data cooperation with an external human resource system, an entry/exit management system, an equipment management system, a cloud service, an on-premises system, a health management system, an emergency call system, and the like via an API, receives, for example, a joining, transfer, or retirement event from the human resource system, a real-time entry/exit event from the entry/exit management system, inspection schedule information from the equipment management system, health condition information from the health management system, emergency response information from the emergency call system, and the like, and immediately reflects them in the user information management unit and the authorization management unit. For example, the API cooperation unit synchronizes authentication information and authority information with an external system such as a cloud storage service or a monitoring camera system, and realizes single sign-on and centralized access control. For example, the API cooperation unit receives inspection schedule information from the equipment management system, and automatically adjusts an access authority of a corresponding inspector. For example, when receiving contract end information of an outsourced contractor, the API cooperation unit immediately revokes all physical and logical access authorities, and stores all operation histories as an audit record. For example, when receiving health abnormality information from the health management system, the API cooperation unit temporarily suspends an access authority of a corresponding user, and notifies an administrator. Specifically, the API cooperation unit implements a routing optimization model based on reinforcement learning. The system includes an event-driven message queue based on a publish-subscribe model. The processing unit buffers an asynchronous message from each external system. The processing unit determines a priority of a message. The generative AI processing unit receives a state vector of network traffic as input data. The input data includes, for example, a response time of each API endpoint. The input data includes, for example, an integer value of the number of messages staying in a queue. The input data includes, for example, numerical data of an error occurrence rate. The generative AI processing unit generates an optimal routing path and retry interval as output data. The output data includes, for example, an IP address of a server to be prioritized. The output data includes, for example, a millisecond numerical value of a backoff time. The output data includes, for example, a threshold value of a timeout. The API cooperation unit dynamically changes a setting of a load balancer based on the output routing path. The API cooperation unit redistributes traffic to prevent system congestion. The API cooperation unit activates a circuit breaker function that automatically disconnects an endpoint where an error continues. The model is subjected to reinforcement learning using a traffic pattern in a simulation environment. The learning process sets a reward function so as to maximize throughput of the entire system. The learning process updates an action value using a Q-learning algorithm. This configuration prevents a failure or delay of an external system from spreading to the system. This configuration brings about a technical effect of maximizing real-time performance of data synchronization. This configuration eliminates a single point of failure in complex inter-system cooperation. This technology can be applied to a large-scale cloud-native application in which thousands of microservices cooperate. This technology can be applied to a data cooperation infrastructure of a financial transaction system in which real-time performance is vital. The system adapts to a dynamic state change of a network without depending on a static routing table. The system autonomously executes complex traffic control that cannot be designed by a human.

The user interface unit provides a screen for a user or an administrator to confirm his/her own account information or authority status, or to perform an application or an approval. For example, when an outsourced contractor applies for an extension of a work period, application information is transmitted from a terminal, the generative AI on the server side analyzes an application content, automatically determines whether a necessary authority is appropriate, and returns feedback of approval or rejection to the terminal. For example, when an equipment inspector acquires a new qualification, the information is input from a terminal, and the AI automatically assigns an access authority to a corresponding equipment. An administrator can browse an audit record or a risk alert by the AI from a terminal, and instruct an additional investigation or a corrective measure as necessary. For example, when a temporary worker applies for exit after an end of an emergency response, the AI automatically evaluates a response content and a stay time, and notifies an administrator of an alert if there is a suspicious point. Specifically, the user interface unit adopts an advanced front-end architecture in which a line-of-sight estimation and an operation prediction model are integrated. The system implements a real-time bidirectional communication protocol using a WebSocket. The processing unit collects an event of a mouse movement or a keystroke from a browser of a user. The processing unit converts the collected event data into a time-series tensor. The generative AI processing unit receives an operation history of a user and mouse trajectory data as input data. The input data includes, for example, a time-series array of XY coordinates of a mouse pointer. The input data includes, for example, an ID of a clicked button. The input data includes, for example, numerical data of a screen stay time. The generative AI processing unit generates a prediction result of information required next as output data. The output data includes, for example, a URL of data to be pre-read. The output data includes, for example, a text of a recommended operation. The output data includes, for example, a suggest character string for input assistance. The user interface unit prefetches data in a background based on the output prediction result. The user interface unit dynamically updates rendering of a screen to improve an experience speed. The user interface unit automatically displays a help pop-up when determining that the user is hesitating. The model is learned as a sequence conversion model using operation logs of a large number of users. The learning process minimizes a cross-entropy error when predicting a next operation. The learning process weights an important operation history using an attention mechanism. This configuration anticipates a thought of a user and instantly presents necessary information. This configuration brings about a technical effect of dramatically reducing a cognitive load required for an application or approval work. This configuration provides an intuitive operation environment that prevents an input error or an application omission. This technology can be applied to a company-wide portal site used by diverse employees with different IT literacy. This technology can be applied to a dashboard of a security operation center that performs incident response where every moment counts. The system dynamically interprets an intention of a user instead of a mere static HTML display. The system makes an interaction between a human and a computer extremely smooth.

The authentication processing unit executes identity authentication when a user or an administrator accesses the system, and prevents spoofing or unauthorized access by combining multi-factor authentication such as password authentication, one-time password authentication, biometric authentication, terminal authentication, face authentication, and voice authentication. For example, when an administrator performs an important authority change, one-time password authentication, fingerprint authentication, or face authentication is requested on a terminal, and an authentication result thereof is transmitted to a server to permit an operation. An authentication history is transmitted to the audit record management unit, and all authentication events are recorded. For example, face authentication and IC card authentication at an entry/exit gate can be combined to strictly perform identity verification. Specifically, the authentication processing unit implements a fusion model in which biometric authentication and behavioral authentication are integrated. The system includes a quantized neural network for performing high-speed inference on an edge device side. The processing unit synchronously acquires a face image from a camera and typing data from a keyboard. The processing unit extracts a landmark feature point from a face image. The generative AI processing unit receives a face image and dynamic data of a keystroke as input data. The input data includes, for example, a landmark coordinate array of a face. The input data includes, for example, pressure data at the time of key press. The input data includes, for example, a millisecond numerical value of a typing interval. The generative AI processing unit generates an integrated identity verification score as output data. The output data includes, for example, a floating-point number of an identity probability of 0.99. The output data includes, for example, a floating-point number of a spoofing probability of 0.01. The output data includes, for example, a boolean value of a re-authentication request. The authentication processing unit permits access only when the output identity probability exceeds a threshold value. The authentication processing unit presents an additional voice authentication prompt when a score is in a boundary region. The authentication processing unit encrypts an authentication result and an extracted feature vector, and transmits them to the audit record management unit. The model is pre-trained using a large-scale multimodal dataset. The learning process maps feature representations between different modalities to the same latent space. The learning process maximizes a margin between an identity and another person using contrastive learning. This configuration sees through spoofing by a behavioral feature even when single biometric information is forged. This configuration brings about a technical effect of achieving both an extremely high security level and user convenience. This configuration shortens a time required for authentication to a millisecond unit and prevents congestion at a gate. This technology can be applied to an entry/exit management system of a government agency that handles national secrets. This technology can be applied to access control of a dealing room of a financial institution involving a large amount of fund transfer. The system continuously verifies a physical and behavioral feature of a user without depending on a static password. The system provides an advanced authentication infrastructure that forms a foundation of a zero trust security model.

As described above, in the embodiment of the present invention, physical entry/exit management and logical system access management in a data center are integrated, and an extremely advanced integrated access management system capable of flexibly and safely responding to diverse operational needs in the field, such as dynamic and optimal authority management by generative AI, real-time detection of an abnormal behavior, an audit record of all operations, automatic synchronization by API cooperation with an external system, authority control considering a health condition and an emergency response history, access control utilizing qualification information and person-in-charge-of-work information, single sign-on, security enhancement by multi-factor authentication, and dynamic authority assignment considering a work schedule and an inspection history, can be realized. For example, it is a configuration capable of finely and real-time responding to diverse field needs, such as an operation of assigning a server room entry authority of an outsourced contractor only during a work period and automatically revoking it after an end of the period, an operation of extracting an access history of a user who entered a server room in a midnight time zone and detecting an abnormal pattern, an operation of immediately invalidating both logical and physical access authorities of a retired user and storing all operation histories as an audit record, an operation of detecting an entry of an equipment inspector into an unscheduled inspection area and immediately notifying an administrator, an operation of automatically suspending an access authority at the time of a health abnormality and reassigning it at the time of return, and an operation of detecting a long-time stay of a temporary worker after an end of an emergency response and notifying an administrator of an alert. Specifically, the entire system is orchestrated by a meta AI model that monitors and controls each subsystem. The system includes an infrastructure for dynamically scaling a containerized microservice group. The processing unit periodically collects health check data from each subsystem. The processing unit aggregates the collected data into a time-series tensor. The meta AI model receives health check data from each subsystem as input data. The input data includes, for example, a percentage of a CPU usage rate. The input data includes, for example, the number of bytes of a memory free space. The input data includes, for example, a consumption amount of a network bandwidth. The meta AI model generates a resource optimization plan of the entire system as output data. The output data includes, for example, the number of containers to be additionally started. The output data includes, for example, an ID of a node to be scaled down. The output data includes, for example, a list of services requiring restart. The system issues a command to an orchestration tool based on the output plan. The system automatically expands a resource when traffic rapidly increases. The system detours traffic to a normal node when a failure occurs. The model is subjected to reinforcement learning using a past system operation log and failure history. The learning process sets a reward function so as to maximize availability of the entire system. The learning process updates a resource allocation policy using a policy gradient method. This configuration dramatically improves fault tolerance of the entire system. This configuration brings about a technical effect of realizing self-repair and self-optimization of the system without intervention of an administrator. This configuration strictly complies with a service level agreement while minimizing an operation cost. This technology can be applied to infrastructure management of a cloud platform that requires 24/7 non-stop operation. This technology can be applied to a disaster recovery system that guarantees business continuity even when a large-scale disaster occurs. The system functions as an autonomous system in which the whole organically cooperates instead of a mere collection of functions. The system provides ultimate flexibility and robustness that surpass a conventional static system architecture.

### (System Configuration)

The system according to the present embodiment comprises a user information management unit, an authorization management unit, an audit record management unit, a generative AI processing unit, an API cooperation unit, a user interface unit, and an authentication processing unit. The user information management unit centrally manages a wide variety of attribute information such as a name, an ID, a role, an affiliated company, an enrollment status, contact information, shift information, an area in charge, a past entry/exit history, qualification information, emergency contact information, a health condition, a work schedule, equipment in charge, an access history, and an entry/exit gate usage history of all users who enter and exit a data center, that is, an operation engineer, a maintenance worker, an outsourced contractor, a security personnel, a cleaning staff member, an equipment inspector, a temporary worker, an auditor, and the like in a database. For example, when an outsourced contractor enters a server room only for a specific period, the period, an area in charge, a work content, a scheduled work time, a person in charge of work, a necessary qualification, presence or absence of a work procedure manual, and emergency contact information can be registered in detail. For example, when an equipment inspector temporarily enters the data center for an annual inspection, a scheduled inspection date, an area in charge, a necessary equipment list, an inspection content, a submission deadline of an inspection result report, and the like can also be recorded. For example, when a cleaning staff member enters a specific area on a fixed day of the week and time zone every week, it can be registered in the shift information as a regular schedule and managed in association with the entry/exit history. For example, when a temporary worker temporarily enters for an emergency response, an emergency response reason, a response content, a response start/end time, a person in charge of the response, a reporting obligation after the response, and the like can also be recorded. Specifically, the present system adopts an advanced data management architecture in which a distributed hash table and a graph database are linked. The present system comprises an in-memory data grid that realizes ultra-low latency data access. The present processing unit expands a complex relationship between a user and a resource on a memory as a graph structure. The present processing unit asynchronously executes invalidation and reconstruction of a cache when updating data. The present generative AI processing unit receives relationship data between a user and a resource as input data. The present input data includes, for example, a pair of a user ID and a resource ID. The present input data includes, for example, a label indicating a type of an access authority. The present input data includes, for example, a time stamp of an expiration date. The present generative AI processing unit generates an update query of a relationship graph as output data. The present output data includes, for example, an SQL command for adding a node. The present output data includes, for example, a numerical value of an edge weight update. The present output data includes, for example, a deletion flag of an unnecessary relationship. The present user information management unit executes a transaction of the database using the output query. The present user information management unit broadcasts an update result to all nodes to maintain consistency. The present user information management unit dynamically recalculates a sharding key of data to prevent a load bias. The present model learns optimization of an execution plan using a past query execution history. The present learning process adjusts a structure of an index so as to minimize a response time of a query. The present learning process searches for an optimal cache strategy using reinforcement learning. The present configuration searches and updates a huge relationship graph consisting of millions of nodes and edges in milliseconds. The present configuration brings about a technical effect of scaling linearly even with an increase in data amount. The present configuration instantaneously resolves a complex authority dependency relationship and eliminates an access delay. The present technology can be applied to an access control infrastructure of a social network service having hundreds of millions of users. The present technology can be applied to a platform that performs authentication and authority management of a huge number of IoT devices. The present system efficiently processes a many-to-many complex relationship that is difficult to process with a conventional relational database. The present system enables intuitive data modeling by a graph operation in a high-dimensional space.

The authorization management unit comprehensively analyzes a role, an affiliated company, a business content, a work schedule, qualification information, a past access record, shift information, an area in charge, a health condition, a person in charge of work, a work content, an emergency response history, and the like of each user using generative AI, and automatically assigns a minimum and optimal logical access authority and physical access authority. For example, an entry authority to a server room and a monitoring room and an operation authority of a server management system are assigned to an operation engineer, an entry authority to the server room and a temporary setting change authority only during a work period are assigned to an outsourced contractor, an entry authority to all areas and all authorities of a monitoring system are assigned to a security personnel, a physical access authority limited only to a cleaning area is assigned to a cleaning staff member, only a physical access authority to a scheduled inspection area and a browsing authority of an equipment management system are assigned to an equipment inspector, and an entry authority to all areas and a log browsing authority only during an audit period are assigned to an auditor. For example, the AI learns a past access history and an anomaly detection history, immediately detects an unusual behavior such as “when an outsourced contractor attempts to enter a power supply room that is not normally accessed”, “when an operation engineer attempts to enter a server room in a midnight time zone”, “when a cleaning staff member attempts to enter an area out of charge”, “when an equipment inspector attempts to enter an unscheduled inspection area”, and “when a temporary worker stays for a long time even after an end of an emergency response”, and notifies an administrator of an alert. For example, based on qualification information, it is also possible to assign an access authority of a specific area or system only to a user having a specific advanced security qualification. For example, when a health condition is determined to be poor, a physical access authority can be temporarily suspended and notified to an administrator. For example, when a person in charge of work is absent, an access authority of a worker can also be temporarily restricted. Specifically, the present authorization management unit implements a hybrid inference architecture integrating a rule-based inference engine and a neural network. The present system comprises a dedicated tensor processing unit for accelerating an inference process. The present processing unit vectorizes and combines a static security policy and dynamic context information. The present processing unit normalizes the combined vector. The present generative AI processing unit receives a vector of a static rule and a dynamic context as input data. The present input data includes, for example, a text vector of a company security policy. The present input data includes, for example, a score of current threat intelligence. The present input data includes, for example, recent behavior history data of a user. The present generative AI processing unit generates a final authority determination result as output data. The present output data includes, for example, a boolean value of an access permission. The present output data includes, for example, an ID list of an applied rule. The present output data includes, for example, a flag indicating a necessity of an exception process. The present authorization management unit immediately reflects the output determination result in an access control list. The present authorization management unit records a rule ID that is a basis of the determination as an audit log. The present authorization management unit performs escalation to a human administrator when the exception process flag is true. The present model is subjected to supervised learning using past success examples and failure examples of authority assignment. The present learning process simultaneously optimizes a branch condition of a decision tree and a weight of a neural network. The present learning process maximizes prediction accuracy while maintaining interpretability of inference. The present configuration realizes flexible authority assignment while satisfying a strict compliance requirement. The present configuration brings about a technical effect of clarifying a determination basis of AI that is easy to become a black box. The present configuration minimizes damage by dynamically narrowing down an authority even against an unknown threat. The present technology can be applied to a strict access control system of a military facility. The present technology can be applied to browsing authority management of an electronic medical record in a medical institution. The present system makes an optimal determination by utilizing both a rule set by a human administrator and a pattern discovered by AI. The present system instantaneously interprets a complex context by a vector operation in a high-dimensional space.

The audit record management unit records in detail all account operations, authority changes, physical entry/exit records, logical system access records, data synchronization histories with an external system by API cooperation, and terminal information of all users together with time information. For example, when an operation engineer enters a server room, logs in to a server management system, changes a setting, and executes a failure response, a series of physical/logical accesses and operation histories thereof are recorded in chronological order. For example, when an outsourced contractor attempts to enter outside a work period, an attempt record thereof and an authentication failure history at a gate also remain in detail. For example, when an equipment inspector submits an inspection result report after an inspection work, a submission history thereof is also stored as an audit record. For an important authority change or account deletion operation, multi-factor authentication of an administrator is required, and an electronic signature is added to an operation record thereof, thereby preventing subsequent falsification or repudiation. The audit record is periodically backed up, and an archive function for long-term storage is also provided. For example, all authority change histories, entry/exit histories, operation histories, and anomaly detection histories for the past five years are safely stored so that they can be quickly searched and extracted as necessary. Specifically, the present audit record management unit implements a multi-task learning model that simultaneously optimizes anomaly detection and data compression. The present system comprises a storage management infrastructure that automatically tiers hot data and cold data. The present processing unit parses a continuously flowing raw audit log stream in real time. The present processing unit determines a storage tier of a storage destination according to an importance of a log. The present generative AI processing unit receives a raw audit log stream as input data. The present input data includes, for example, trace data of a system call. The present input data includes, for example, header information of a network packet. The present input data includes, for example, an error log text of an application. The present generative AI processing unit generates compressed log data and an anomaly flag as output data. The present output data includes, for example, reversibly compressed binary data. The present output data includes, for example, an index of a log line including an anomaly. The present output data includes, for example, a category score indicating an importance. The present audit record management unit writes the output binary data to a designated storage tier. The present audit record management unit transmits a notification to a real-time dashboard when the anomaly flag is true. The present audit record management unit asynchronously updates a search index to maintain a response speed of a query. The present model is subjected to self-supervised learning using a huge amount of past log data. The present learning process optimizes a trade-off between a reconstruction error of data and a compression rate. The present learning process learns a latent space of a variational autoencoder. The present configuration enables instantaneous search of necessary information while efficiently storing petabyte-class log data. The present configuration brings about a technical effect of dramatically reducing a storage cost. The present configuration completely prevents falsification or deletion of a log and satisfies a requirement of evidence preservation. The present technology can be applied to a long-term storage system of a huge communication log of a communication carrier. The present technology can be applied to a compliance archive system that stores all transaction histories of a financial institution. The present system dynamically changes a storage strategy by understanding a semantic importance of a log instead of simple data compression. The present system discovers an unknown anomaly pattern from a log by feature extraction in a high-dimensional space.

The generative AI processing unit integrally analyzes diverse data such as user information, authority assignment histories, audit records, system usage statuses, event information from an external system, a health condition, a work schedule, an emergency response history, an equipment inspection history, and a cleaning history, and detects an unusual access or authority change in real time using an anomaly detection algorithm. For example, the AI automatically extracts an anomaly pattern such as when a user who does not normally access enters an important area in a midnight time zone, when an outsourced contractor attempts to enter a power supply room, when an account of a retired user is illegally used, when a cleaning staff member enters an area out of charge, when an equipment inspector enters an unscheduled inspection area, and when a temporary worker stays for a long time even after an end of an emergency response, and performs risk notification to an administrator. For example, the AI can analyze an authority setting error and a tendency of personalization from an operation history of an administrator and a past audit record, automatically report a risk such as “authority assignment errors by a specific administrator occur frequently”, “suspicious accesses by a specific outsourced contractor occur frequently”, and “abnormal accesses are concentrated in a specific area”, and propose a necessity of a corrective measure or education. For example, the AI can analyze a history of user movement or authority transfer between a plurality of data center bases, and automatically evaluate and adjust consistency of a security policy between the bases. For example, the AI can analyze an equipment inspection history and a cleaning history, detect an omission of work or an illegal work execution, and report it to an administrator. Specifically, the present generative AI processing unit implements a transformer-based neural network model provided with a self-attention mechanism. The present generative AI processing unit generates a multidimensional numerical vector including attribute information of a user, an access time, position information coordinates, and a biometric authentication score as input data. The present generative AI processing unit receives, for example, a 512-dimensional time-series tensor as input data. The present generative AI processing unit executes a normalization process and a missing value completion process on the input data. The present generative AI processing unit uses a vector including a user identifier, an access request time, a target area identifier, and the number of accesses in the latest 24 hours as an example of the input data. The present generative AI processing unit uses a tensor obtained by converting a natural language text indicating an operation history of an administrator into a word embedding vector as another input example. The present generative AI processing unit calculates an anomaly score by operating these input tensors in a high-dimensional space. The present generative AI processing unit outputs an anomaly probability score taking a continuous value in a range of zero to one as output data. The present generative AI processing unit outputs a numerical value indicating that an anomaly probability for a specific access request is 0.95 as an example of the output data. The present generative AI processing unit outputs a classification label indicating a possibility of an authority setting error and a certainty factor thereof as another output example. The present generative AI processing unit generates an access blocking command as a subsequent process when the output anomaly probability score exceeds a preset threshold value. The present generative AI processing unit transmits the generated command to an access control module. The present generative AI processing unit adopts a calculation method of a reconstruction error using an autoencoder as an anomaly detection algorithm. The present generative AI processing unit pre-learns the autoencoder using a data set of a normal access pattern. The present generative AI processing unit uses a mean square error as an error function during learning. The present generative AI processing unit optimizes a weight parameter of a network by a gradient descent method. The present generative AI processing unit calculates a difference between the input access data and the reconstructed data. The present generative AI processing unit determines an anomaly when this difference is larger than a predetermined reference value. The present generative AI processing unit instantaneously specifies a minute anomaly pattern that is difficult to discover by human visual monitoring by this process. The present generative AI processing unit brings about a technical effect of preventing occurrence of a security incident as a result. The present generative AI processing unit is applied to a use case such as physical security management of a data center and access monitoring to an important system of a financial institution. The present generative AI processing unit expresses a policy setting value of each base as graph structure data when evaluating consistency of a security policy between bases. The present generative AI processing unit extracts a difference in setting between bases using a graph neural network. The present generative AI processing unit recommends an optimal policy setting value based on the extracted difference. The present generative AI processing unit transmits this recommendation result to a terminal of an administrator. The present generative AI processing unit thereby significantly improves calculation efficiency of security management in a large-scale distributed system.

The API cooperation unit performs data cooperation with an external human resource system, an entry/exit management system, an equipment management system, a cloud service, an on-premises system, a health management system, an emergency notification system, and the like via an API, receives, for example, a joining, transfer, or retirement event from the human resource system, a real-time entry/exit event from the entry/exit management system, inspection schedule information from the equipment management system, health condition information from the health management system, emergency response information from the emergency notification system, and the like, and immediately reflects them in the user information management unit and the authorization management unit. For example, authentication information and authority information are synchronized with an external system such as a cloud storage service and a surveillance camera system to realize single sign-on and centralized access control. For example, inspection schedule information from the equipment management system is received, and an access authority of a corresponding inspector is automatically adjusted. For example, when contract end information of an outsourced contractor is received, all physical and logical access authorities are immediately revoked, and all operation histories are stored as an audit record. For example, when health abnormality information is received from the health management system, an access authority of a corresponding user is temporarily suspended and notified to an administrator. Specifically, the present API cooperation unit maintains a constant connection with a plurality of external systems using an asynchronous communication protocol. The present API cooperation unit converts received event data into a standardized JSON format data structure. The present API cooperation unit stores the converted data in a message queuing system. The present API cooperation unit sequentially extracts data from a message queue and executes a data cleansing process. The present API cooperation unit performs deletion of an unnecessary character and unification of a date format in the data cleansing process. The present API cooperation unit writes the processed data to a distributed database of the user information management unit. The present API cooperation unit executes this series of processes with a delay in milliseconds. The present API cooperation unit adopts a mutual authentication method in communication with an external system. The present API cooperation unit protects a communication path by an encryption protocol. The present API cooperation unit acquires a time-series numerical array of a heart rate and a body temperature as health abnormality information received from the health management system. The present API cooperation unit expands the acquired time-series numerical array on a memory as a one-dimensional tensor. The present API cooperation unit inputs this tensor to an abnormality determination module. The present API cooperation unit receives a control flag instructing temporary suspension of an access authority as an output from the abnormality determination module. The present API cooperation unit transmits an authority revocation command to the authorization management unit based on this control flag. The present API cooperation unit minimizes a delay of data synchronization between systems by this mechanism. The present API cooperation unit exhibits a technical effect of eliminating a risk that an account of a retired person or a person whose contract has ended is left unattended as a result. The present API cooperation unit is applied to a use case such as access authority management of a staff member in a large-scale medical institution and entry/exit management of an external contractor in a manufacturing plant. The present API cooperation unit uses an open authentication and authorization protocol in synchronization with a cloud storage service. The present API cooperation unit dynamically generates an access token and transmits it to an external system. The present API cooperation unit strictly manages an expiration date of a token. The present API cooperation unit automatically discards an access request using an expired token. The present API cooperation unit thereby maintains a high security level while reducing a communication load on a network.

The user interface unit provides a screen for a user or an administrator to confirm his/her own account information or authority status, or to perform an application or an approval. For example, when an outsourced contractor applies for an extension of a work period, application information is transmitted from a terminal, the generative AI on the server side analyzes an application content, automatically determines whether a necessary authority is appropriate, and returns feedback of approval or rejection to the terminal. For example, when an equipment inspector acquires a new qualification, the information is input from a terminal, and the AI automatically assigns an access authority to corresponding equipment. An administrator can browse an audit record or a risk alert by the AI from a terminal, and instruct an additional investigation or a corrective measure as necessary. For example, when a temporary worker applies for exit after an end of an emergency response, the AI automatically evaluates a response content and a stay time, and notifies an administrator of an alert if there is a suspicious point. Specifically, the present user interface unit comprises a dynamic web page generation engine. The present user interface unit transmits screen data composed of HTML and JavaScript to a terminal of a user. The present user interface unit transfers input data from a terminal to a server by asynchronous communication. Upon receiving application information, the present user interface unit delivers data to the generative AI processing unit including a natural language processing model. The present generative AI processing unit receives a data set including a text character string describing an application reason, an identifier of an applicant, and an identifier of a requested authority as input data. The present generative AI processing unit tokenizes an input text and converts it into a word embedding vector. The present generative AI processing unit uses a text vector “I want to extend a work time by two hours for a firmware update of a network device” as an example of the input data. The present generative AI processing unit uses structured data including a name of a newly acquired qualification and an acquisition date as another input example. The present generative AI processing unit inputs these pieces of input data to a multilayer perceptron and calculates an appropriateness score. The present generative AI processing unit outputs an appropriateness probability score in a range of zero to one as output data. The present generative AI processing unit outputs an appropriateness score of 0.88 for an extension application as an example of the output data. The present generative AI processing unit outputs a binary flag indicating propriety of authority assignment based on qualification information as another output example. The present generative AI processing unit generates an automatic approval command as a subsequent process when the output score exceeds a predetermined threshold value. The present generative AI processing unit generates an escalation request to an administrator when the score is less than the threshold value. The present user interface unit receives this determination result and immediately displays an approval or rejection message on a screen of a terminal. The present user interface unit reduces a manual approval work of an administrator by this process. The present user interface unit brings about a technical effect of dramatically improving a processing speed of an authority assignment process as a result. The present user interface unit is applied to a use case such as a global IT support desk of a multinational company and authority management of a worker at a large-scale construction site. The present user interface unit generates a graph or a heat map using a data visualization library when displaying a risk alert. The present user interface unit configures a screen so that an administrator can intuitively grasp an abnormal part. The present user interface unit thereby improves interaction efficiency between a human and a computer.

The authentication processing unit executes identity authentication when a user or an administrator accesses a system, and prevents spoofing or unauthorized access by combining multi-factor authentication such as password authentication, one-time password authentication, biometric authentication, terminal authentication, face authentication, and voice authentication. For example, when an administrator performs an important authority change, one-time password authentication, fingerprint authentication, or face authentication is requested on a terminal, and an authentication result thereof is transmitted to a server to permit an operation. An authentication history is transmitted to the audit record management unit, and all authentication events are recorded. For example, strict identity verification can be achieved by combining face authentication and IC card authentication at an entry/exit gate. Specifically, the present authentication processing unit comprises an authentication orchestrator that integrally manages a plurality of authentication modules. The present authentication processing unit receives two-dimensional image data acquired from a camera of a terminal as an input when executing face authentication. The present authentication processing unit executes a preprocessing of clipping and normalization of a face region on the input image data. The present authentication processing unit converts the preprocessed image data into a three-dimensional image tensor. The present authentication processing unit inputs this image tensor to a convolutional neural network. The present authentication processing unit uses a 224-pixel square RGB image tensor as an example of the input data. The present authentication processing unit uses two-dimensional array data including a mel-frequency cepstrum coefficient for voice authentication as another input example. The present authentication processing unit extracts a 512-dimensional feature vector from an input image using a convolutional neural network. The present authentication processing unit calculates a cosine similarity between the extracted feature vector and a reference vector pre-registered in a database. The present authentication processing unit outputs a similarity score in a range of zero to one as output data. The present authentication processing unit outputs a similarity score of 0.97 for face authentication as an example of the output data. The present authentication processing unit outputs a boolean value indicating a matching success of voice authentication as another output example. The present authentication processing unit generates an authentication success token as a subsequent process when the output similarity score exceeds a set authentication threshold value. The present authentication processing unit transmits the generated token to a session management module. The present authentication processing unit implements a risk-based authentication algorithm that dynamically determines a combination of multi-factor authentication. The present authentication processing unit calculates a risk score based on an IP address of an access source and a time zone. The present authentication processing unit transmits a control signal requesting additional biometric authentication to a terminal when the risk score is high. The present authentication processing unit significantly improves authentication accuracy by this mechanism as compared with a conventional system depending on static password authentication. The present authentication processing unit exhibits a technical effect of reducing an information leakage risk due to unauthorized access to the utmost limit as a result. The present authentication processing unit is applied to a use case such as a confidential information management system of a government agency and a core banking system of a financial institution. The present authentication processing unit hashes authentication history data using a cryptographic hash function. The present authentication processing unit asynchronously transmits the hashed data to the audit record management unit. The present authentication processing unit thereby realizes reliable log recording without reducing a response speed of an authentication process.

Specific examples of a prompt sentence to be read by generative AI necessary for carrying out the present invention include “Assign a server room entry authority of an outsourced contractor only during a work period, and automatically revoke it after an end of the period”, “Extract an access history of a user who entered a server room in a midnight time zone, and detect an anomaly pattern”, “Analyze a past entry/exit history of a user having an access authority to a power supply room, and list an unusual behavior”, “Immediately invalidate both logical and physical access authorities of a retired user, and store all operation histories as an audit record”, “Analyze a tendency of an authority assignment operation by an administrator, and extract a case with a high risk of an error or personalization”, “Detect an entry of an equipment inspector into an unscheduled inspection area, and immediately notify an administrator”, “Automatically suspend an access authority temporarily at the time of a health abnormality, and reassign it at the time of return”, and “Detect a long stay of a temporary worker after an end of an emergency response, and notify an administrator of an alert”. Specifically, the present system uses these prompt sentences as input data to a natural language processing model. The present system divides a character string constituting a prompt sentence into subword units, and converts it into a one-dimensional array of token IDs. The present system uses a token array including an instruction “Assign a server room entry authority of an outsourced contractor only during a work period, and automatically revoke it after an end of the period” as an example of the input data. The present system uses a text character string obtained by formatting access history data extracted from a system log in a JSON format in combination with a prompt as another input example. The present system inputs these pieces of input data to an encoder layer of a large language model. The present system calculates a dependency relationship between each word in a prompt using a self-attention mechanism inside a large language model. The present system generates a sequence of specific system commands to be executed as output data. The present system outputs a calling code of an authority assignment API for a specific user ID as an example of the output data. The present system outputs structured report data summarizing an anomaly detection result in a JSON format as another output example. The present system passes the output command sequence to a syntax analysis module and converts it into an executable format. The present system transmits the converted command to each control module, and executes an actual authority change or alert notification. The present system combines a template-based generation method and dynamic parameter embedding in generation of a prompt sentence. The present system automatically selects an optimal prompt template according to a state of the system or a type of an event. The present system embeds a user ID and time information in the selected template, and constructs a final prompt sentence. The present system saves time and effort for a human to manually input a complex setting command by this process. The present system brings about a technical effect of increasing an automation level of system operation and preventing a security accident due to a setting error as a result. The present system is applied to a use case such as automatic operation management of a cloud infrastructure and unmanned operation of a large-scale data center. The present system performs fine tuning using a specialized corpus related to system operation in learning of a large language model. The present system thereby acquires an ability to generate an operation command with higher accuracy than a general language model.

### (Implementation Steps)

Step 1: Detailed registration of user information and external cooperation. For all users entering and exiting a data center, the user information management unit centrally registers and manages a wide variety of attribute information such as a name, an ID, a role, an affiliated company, an enrollment status, contact information, shift information, an area in charge, a past entry/exit history, qualification information, emergency contact information, a health condition, a work schedule, an equipment in charge, an access history, and an entry/exit gate usage history of an operation engineer, a maintenance worker, an outsourced contractor, a security personnel, a cleaning staff member, an equipment inspector, a temporary worker, an auditor, and the like, performs API cooperation with a human resource system, an entry/exit management system, an equipment management system, a health management system, an emergency notification system, and the like, receives event information such as joining, transfer, retirement, a work schedule, a health condition, and an emergency response in real time, and automatically synchronizes and updates the user information. Specifically, the user information management unit includes a distributed relational database system. The user information management unit stores the attribute information of each user in a normalized table structure. The user information management unit receives event data received from an external system as an input. The user information management unit uses, as an example of input data, data in an XML format including a name, an employee number, and an assigned department of a new employee transmitted from the human resource system. The user information management unit uses, as another input example, data in a JSON format including a gate passage time and an IC card identifier transmitted from the entry/exit management system. The user information management unit parses the received data and maps the received data to an internal data schema. The user information management unit writes the mapped data to a corresponding record in a database. The user information management unit performs transaction management in this writing process to guarantee data consistency. When the data update is completed, the user information management unit generates an update completion notification event as output data. The user information management unit outputs, as an example of the output data, a message indicating that a status of a specific user ID has been changed from “enrolled” to “retired”. The user information management unit outputs, as another output example, an alert flag indicating that a health condition parameter has deviated from a normal range. The user information management unit transmits the generated event to the authorization management unit via a message broker. As a subsequent process, the user information management unit causes the authorization management unit to execute recalculation of an authority triggered by this event. The user information management unit uses an in-memory cache system together in order to improve search performance of the database. The user information management unit holds frequently accessed user information in a cache memory. Thereby, the user information management unit reduces an inquiry load on the database. As a result, the user information management unit exhibits a technical effect of maintaining a response speed in milliseconds even in an environment handling user information on a scale of tens of thousands of people. The user information management unit is applied to use cases such as a resident ID management infrastructure of a large-scale smart city and a global human resource information integration system of a multinational corporation. The user information management unit executes a data backup process asynchronously, enabling quick recovery in the event of a failure.
Step 2: Dynamic authority assignment and adjustment by generative AI. In the authorization management unit, generative AI is utilized to comprehensively analyze a role, an affiliated company, a business content, a work schedule, qualification information, a past access record, shift information, an area in charge, a health condition, a work supervisor, a work content, an emergency response history, and the like of each user, automatically assign a minimum and optimal logical access authority and physical access authority, and adjust the authority in real time according to changes in a work period, the area in charge, the health condition, presence or absence of a qualification, an emergency response status, and the like. Specific examples of a prompt sentence to be read by the generative AI include “assign a server room entry authority of an outsourced contractor only during a work period, and automatically revoke the authority after the period ends”, “automatically suspend an access authority temporarily at the time of a health abnormality, and reassign the access authority at the time of return”, “detect an entry of an equipment inspector into an area outside an inspection schedule, and immediately notify an administrator”, and “dynamically control an access authority of a specific area or system based on qualification information”. Specifically, the authorization management unit implements a deep reinforcement learning model as the generative AI. The authorization management unit inputs attribute information and context information of a user as a state vector. The authorization management unit uses, as an example of input data, a 128-dimensional numerical vector including a job title ID of the user, a current time, an importance level of a target system, and a latest health condition score. The authorization management unit uses, as another input example, a timestamp array of a start time and an end time extracted from a work schedule. The authorization management unit inputs these pieces of input data to a multi-layer neural network, and calculates a probability distribution of whether or not each authority should be assigned. The authorization management unit outputs, as output data, a vector indicating an assignment probability for all authorities in the system. The authorization management unit outputs, as an example of the output data, an array including an assignment probability of 0.99 for a physical access authority to a server room and an assignment probability of 0.01 for a database administrator authority. The authorization management unit outputs, as another output example, a natural language text character string explaining a reason for an authority change. The authorization management unit extracts an authority whose output probability exceeds a predetermined threshold, and generates an update command for an access control list as a subsequent process. The authorization management unit transmits the generated command to an access control gateway of each system. The authorization management unit sets an occurrence rate of a security incident as a negative reward and smoothness of business execution as a positive reward as a reward function of reinforcement learning. The authorization management unit continuously updates weights of the model using a past access log and an incident history. By this process, the authorization management unit realizes flexible authority control according to a situation, which cannot be handled by static rule-based authority management. As a result, the authorization management unit brings about a technical effect of maximizing business efficiency while eliminating a security risk due to excessive authority assignment. The authorization management unit is applied to use cases such as a strict access control system of a military facility and authority management on a trading floor of a financial institution. The authorization management unit records an adjustment history of an authority in a blockchain network to ensure transparency of an audit.
Step 3: Immediate change and revocation of an authority by an event trigger. Via the API cooperation unit, event information such as joining, transfer, retirement, end of a work period, health abnormality, and end of an emergency response is received in real time from a human resource system, an entry/exit management system, an equipment management system, a health management system, an emergency notification system, and the like, an authority of a corresponding user is immediately assigned, changed, or revoked, and all authority change histories are recorded in the audit record management unit. For example, this includes end of a contract of an outsourced contractor, end of an inspection work of an equipment inspector, temporary suspension of an access authority when a health abnormality occurs, revocation of an authority of a temporary worker after an emergency response ends, and the like. Specifically, the system adopts an event-driven architecture. The system includes an event router module, and branches a process according to a type of a received event. The system receives, as input data, a structured payload including an event source system identifier, an event type code, a target user ID, and an occurrence time. The system uses, as an example of the input data, a JSON object including an event code indicating “retirement” issued from the human resource system and an employee number of a corresponding person. The system uses, as another input example, alert data indicating “body temperature abnormality” transmitted from the health management system. The system inputs these pieces of input data to an event processing engine. The system infers a necessary action using a predefined rule engine or a learned decision tree model in the event processing engine. The system generates, as output data, a group of API requests for executing an authority change. The system outputs, as an example of the output data, an account invalidation command for an active directory. The system outputs, as another output example, an entry permission cancellation command for a physical electronic lock system. The system transmits the generated command to each target system in parallel as a subsequent process. The system waits for an execution completion response from each system, and confirms that all processes have succeeded. The system formats a processing result as an audit log, and transmits the audit log to the audit record management unit. The system completes this series of processes within several hundred milliseconds from event reception. Thereby, the system completely eliminates a time lag when a human administrator manually changes an authority. As a result, the system exhibits a technical effect of physically preventing malicious data removal immediately after retirement or dangerous work by a person with a health abnormality. The system is applied to use cases such as a worker management system of a nuclear power plant and entry/exit management in a laboratory with a high biosafety level. When communication to a target system fails due to a network failure or the like, the system automatically executes a retry process using an exponential backoff algorithm.
Step 4: Detailed collection and falsification prevention of an audit record. In the audit record management unit, account operations, authority changes, physical entry/exit records, logical system access records, data synchronization histories with an external system by API cooperation, and terminal information of all users are recorded in detail together with time information, multi-factor authentication and an electronic signature are required for an important authority change or account deletion operation, and falsification or repudiation of an audit record is prevented. The audit record is periodically backed up, and an archive function for long-term storage is also provided. Specifically, the audit record management unit is constructed based on an append-only distributed ledger technology. The audit record management unit receives log data transmitted from each module as an input. The audit record management unit uses, as an example of input data, a log entry including a user ID of an operator, a resource URI of an operation target, an executed HTTP method, and a timestamp of an operation date and time. The audit record management unit uses, as another input example, a biometric authentication result of an administrator accompanying an authority change operation and electronic signature data by a public key cryptosystem. The audit record management unit calculates a hash value for the input log data using a SHA-256 algorithm. The audit record management unit combines a hash value of an immediately preceding log entry and current log data to generate a new hash value, thereby forming a cryptographic chain structure. The audit record management unit outputs, as output data, a log record confirmed as a new block on a blockchain. The audit record management unit outputs, as an example of the output data, a transaction ID whose unfalsifiability is guaranteed. The audit record management unit outputs, as another output example, a list of log data sorted in chronological order as a response to a log search query for an auditor. The audit record management unit asynchronously transfers the confirmed log data to a cold storage as a subsequent process, and archives the log data. In verification of the electronic signature, the audit record management unit mathematically proves validity of the signature using a certificate acquired from a certificate authority. By this process, the audit record management unit makes it impossible even for an internal offender or a privileged administrator to falsify or delete a past operation history. As a result, the audit record management unit brings about a technical effect of dramatically improving auditability of the system and strictly satisfying compliance requirements. The audit record management unit is applied to use cases such as operation log management of a financial accounting system of a listed company and access record management of an electronic medical record in a medical institution. In order to optimize a storage capacity of log data, the audit record management unit automatically compresses data after a certain period of time has elapsed with a compression algorithm, and reduces a storage cost.
Step 5: Anomaly detection and risk alert by generative AI. In the generative AI processing unit, diverse data such as user information, authority assignment histories, audit records, system usage statuses, event information from an external system, a health condition, a work schedule, an emergency response history, an equipment inspection history, and a cleaning history are integrally analyzed, and an abnormal pattern such as an unusual access or authority change, an entry into an area outside charge, a suspicious behavior in a midnight time zone, an access attempt by a retired user, or a long stay of a temporary worker is detected in real time using an anomaly detection algorithm, and a risk notification or a proposal of a corrective measure is performed to an administrator. Specific examples of a prompt sentence to be read by the generative AI include “extract an access history of a user who entered a server room in a midnight time zone, and detect an abnormal pattern”, “immediately invalidate both logical and physical access authorities of a retired user, and save all operation histories as an audit record”, “detect a long stay of a temporary worker after an emergency response ends, and notify an administrator of an alert”, and “analyze a tendency of an authority assignment operation by an administrator, and extract a case with a high risk of an error or personalization”. Specifically, the generative AI processing unit implements a long short-term memory network specialized for analysis of time-series data. The generative AI processing unit integrates a wide variety of log data collected from the entire system, and generates a feature amount tensor for each certain time frame as input data. The generative AI processing unit uses, as an example of the input data, a multidimensional vector whose elements are the number of entries into each area, the number of login failures to a system, and the number of authority change operations in the past one hour. The generative AI processing unit uses, as another input example, a tensor obtained by encoding a behavior history of a specific user for the past one month as sequence data. The generative AI processing unit inputs these pieces of input data to the long short-term memory network, and calculates how much a current behavior pattern deviates from a past normal pattern. The generative AI processing unit outputs, as output data, an array of anomaly scores for each user or each system component. The generative AI processing unit outputs, as an example of the output data, an anomaly score of 0.92 indicating that a stay time of a temporary worker significantly exceeds a predicted value. The generative AI processing unit outputs, as another output example, a natural language text explaining a cause of an anomaly and a list of recommended corrective measures. When the output anomaly score exceeds a warning threshold, the generative AI processing unit activates an alert generation module as a subsequent process. The alert generation module transmits a push notification to a smartphone terminal of an administrator. In learning of an anomaly detection model, the generative AI processing unit combines supervised learning using data of a past security incident as teacher data and unsupervised learning using only normal data. By this hybrid learning method, the generative AI processing unit detects not only a known attack pattern but also an unknown zero-day attack or a sign of internal fraud with high accuracy. As a result, the generative AI processing unit exhibits a technical effect of realizing automation and sophistication of a security monitoring business and dramatically shortening an incident response time. The generative AI processing unit is applied to use cases such as a national-scale critical infrastructure protection system and unauthorized access monitoring of a large-scale EC site. In order to reduce false positives, the generative AI processing unit provides a mechanism in which an administrator can input feedback to an alert, and uses the feedback for relearning of the model.
Step 6: Application, approval, and information update by a user interface. In the user interface unit, a screen for a user or an administrator to check their own account information or authority status, or to perform an application or approval is provided, and for example, when an outsourced contractor applies for an extension of a work period, when an equipment inspector declares a new qualification, or when a temporary worker applies for exit after an emergency response ends, application information is transmitted from a terminal, the generative AI on the server side analyzes an application content, automatically determines whether a necessary authority is appropriate, and returns feedback of approval or rejection to the terminal. Specifically, the user interface unit adopts a single-page application architecture, and operates at high speed on a terminal of a user. The user interface unit detects an input operation from a user, and constructs input data as a payload in a JSON format. The user interface unit uses, as an example of the input data, a data object including a text describing a reason for work extension, a desired extension time, and a current work progress rate. The user interface unit uses, as another input example, multipart form data including image data of an uploaded qualification certificate and a name of the qualification. The user interface unit transmits these pieces of input data to the generative AI processing unit on the server side via a RESTful API. The generative AI processing unit applies a natural language processing model to text data, applies an optical character recognition model to image data, and extracts information. Based on the extracted information, the generative AI processing unit compares and collates the application content with a current system state. The generative AI processing unit outputs, as output data, an approval probability score for the application and a text indicating a reason for determination. The generative AI processing unit outputs, as an example of the output data, an approval probability of 0.95 for a work extension application and a reason text “appropriate because it matches an average required time of past similar work”. The generative AI processing unit outputs, as another output example, a warning flag indicating a possibility of forgery of a qualification certificate. When the approval probability exceeds a threshold, the generative AI processing unit transmits an authority update command to the authorization management unit as a subsequent process. The user interface unit receives a response from the server, and dynamically updates a status display on the screen. By this process, the user interface unit completely digitalizes a complicated approval workflow using a paper-based application form or an e-mail. As a result, the user interface unit brings about a technical effect of dramatically shortening a lead time from application to authority assignment from several days to several seconds. The user interface unit is applied to use cases such as a temporary application for an electronic medical record access authority of a doctor in a large-scale hospital and an application for use of research equipment by a student in a university. The user interface unit includes a function of temporarily saving application data in a local storage when offline and automatically transmitting the application data when communication is restored so as to operate even in an environment where a communication line is unstable.
Step 7: Security enhancement by multi-factor authentication. In the authentication processing unit, identity authentication when a user or an administrator accesses the system is executed, multi-factor authentication such as password authentication, one-time password authentication, biometric authentication, terminal authentication, face authentication, and voice authentication is combined to prevent spoofing and unauthorized access, and an authentication history is transmitted to the audit record management unit to record all authentication events. Specifically, the authentication processing unit functions as an authentication gateway based on a zero-trust security model. Upon receiving an access request from a user, the authentication processing unit collects authentication context data. The authentication processing unit uses, as an example of input data, a data set including a hash value of a password input by the user, a MAC address of a terminal, and latitude and longitude coordinates acquired from a GPS. The authentication processing unit uses, as another input example, a biometric feature amount vector acquired from a fingerprint sensor of a smartphone terminal. The authentication processing unit inputs these pieces of input data to an authentication evaluation engine. The authentication evaluation engine includes a machine learning-based behavior analysis model. The authentication evaluation engine compares the input context data with a past standard behavior profile of the user. The authentication evaluation engine outputs, as output data, a risk score for a current access request in a range from 0 to 100. The authentication evaluation engine outputs, as an example of the output data, a risk score of 85 for an access request from an overseas IP address different from usual. The authentication evaluation engine outputs, as another output example, a risk score of 5 for an access from a legitimate internal network. Based on the output risk score, the authentication processing unit dynamically determines the number of authentication factors to be requested as a subsequent process. When the risk score is high, the authentication processing unit transmits a prompt requesting face authentication in addition to a one-time password to the terminal. The authentication processing unit issues an access permission token only when all requested authentication factors are cleared. By this dynamic multi-factor authentication mechanism, the authentication processing unit optimizes a trade-off between convenience and security. As a result, the authentication processing unit exhibits a technical effect of physically and logically preventing account hijacking due to a password list attack or a phishing scam. The authentication processing unit is applied to use cases such as a customer login system of a crypto asset exchange and VPN access control in a telework environment of a company. The authentication processing unit encrypts all metadata collected during an authentication process, and transfers the metadata to the audit record management unit through a secure communication channel.

### (Specific Use Case)

For example, when an outsourced contractor performs equipment replacement work in a server room in a data center, the user information management unit registers in detail a name, an ID, an affiliated company, a scheduled work period, an area in charge, a necessary qualification, emergency contact information, a work supervisor, a past entry/exit history, a health condition, a work content, and the like of the contractor, cooperates with a human resource system, an entry/exit management system, and a health management system via the API cooperation unit, and automatically synchronizes all information before the work starts. The authorization management unit automatically assigns a physical access authority to the server room and a logical access authority necessary for equipment replacement (setting change, log browsing, failure response authority, etc.) only during the work period using the generative AI. At the end of the work period, the AI automatically revokes all authorities, and records a history thereof in detail in the audit record management unit. During the work, the AI monitors a passage time of an entry/exit gate, a usage status of an operation terminal, and a system access log in real time, and immediately notifies an administrator of an alert when detecting, for example, an entry into an area outside charge or in a midnight time zone, an operation pattern different from usual, or an entry attempt when a health abnormality occurs. When an equipment inspector temporarily enters the data center for an annual inspection, an inspection scheduled date, an area in charge, a necessary equipment list, an inspection content, qualification information, and the like are registered, the AI assigns a physical access authority to a corresponding area and a browsing authority of an equipment management system only during an inspection period, and automatically revokes the authorities after the inspection ends. When a cleaning staff member enters a room for regular cleaning, a physical access authority limited only to a cleaning area is assigned in conjunction with shift information, and when an entry into an area outside charge is attempted, the AI immediately detects it as an anomaly and notifies an administrator. When a temporary worker enters for an emergency response, an emergency response reason, a response content, a response start/end time, and the like are registered, and the AI issues an alert when detecting a long stay after the response ends or when detecting an entry into an area different from the response content. When an administrator performs an important operation such as authority assignment or account deletion, multi-factor authentication and an electronic signature are required, and all operation histories are recorded in the audit record management unit. The AI analyzes all these histories, automatically extracts an authority assignment error or a tendency of personalization by a specific administrator, abnormal access concentration in a specific area, omission of equipment inspection or cleaning work, unauthorized work execution, and the like, and proposes a necessity of a corrective measure or education to an administrator. Specifically, the system processes these diverse use cases on a single integrated platform. In equipment replacement work by an outsourced contractor, the system inputs work instruction data to a natural language processing model. The system uses, as an example of input data, a composite data set including text data “router replacement work in rack A, required time 3 hours” and a biometric authentication template of the contractor. The system uses, as another input example, shift table data of a cleaning staff member and three-dimensional coordinate data of a cleaning target area. The system analyzes these pieces of input data, and calculates a scope of an authority to be assigned to each user. The system outputs, as output data, difference data of an access control list for each user. The system outputs, as an example of the output data, an SSH connection permission rule to a specific IP address band for an outsourced contractor. The system outputs, as another output example, an unlocking permission token of a specific electronic lock for a cleaning staff member. Triggered by a timer event indicating that a work period has ended, the system automatically executes an authority revocation script which is a subsequent process. In monitoring during work, the system utilizes a stream data processing engine. The system expands a gate passage log and a command execution log on a memory in real time, and inputs them to an anomaly detection model. As an output of the anomaly detection model, the system calculates a risk score for each behavior. When the risk score exceeds a threshold, the system immediately transmits a control signal to lock down a physical gate. When analyzing an operation history of an administrator, the system models a relationship between the administrator and an authority assignment target person as a network diagram using a graph database. The system calculates a centrality index of a network, and quantitatively evaluates a personalization state in which authority assignment operations are concentrated on a specific administrator. By this process, the system completely automates access management of diverse personnel in a complex facility. As a result, the system brings about a technical effect of preventing occurrence of a security hole due to a human error and significantly reducing an operation cost. The system is applied to use cases such as a hyperscale data center of a mega cloud provider and management of a high-security building occupied by many tenants. The system sorts and displays extracted proposals of corrective measures in descending order of priority on a dashboard.

Specific examples of a prompt sentence to be read by the generative AI include “assign a server room entry authority of an outsourced contractor only during a work period, and automatically revoke the authority after the period ends”, “extract an access history of a user who entered a server room in a midnight time zone, and detect an abnormal pattern”, “detect an entry of an equipment inspector into an area outside an inspection schedule, and immediately notify an administrator”, “detect an entry attempt of a cleaning staff member into an area outside charge, and notify an administrator of an alert”, “detect a long stay of a temporary worker after an emergency response ends, and notify an administrator of an alert”, “immediately invalidate both logical and physical access authorities of a retired user, and save all operation histories as an audit record”, “analyze a tendency of an authority assignment operation by an administrator, and extract a case with a high risk of an error or personalization”, and “detect omission of equipment inspection or cleaning work or unauthorized work execution, and report to an administrator”. Specifically, the system includes a prompt engineering module that dynamically generates these prompt sentences and transmits them to an inference API of a large language model. The system receives, as input data, raw event log data generated in the system and a set of predefined system constraint rules. The system uses, as an example of the input data, spatial information data including an ID of a cleaning staff member, sensor coordinates of a current position, and polygon data of a permitted cleaning area. The system uses, as another input example, difference data between a work completion report text of an equipment inspector and an actual equipment operation log. The system embeds these pieces of input data into a prompt sentence as a context. The system executes inference based on the input context using the large language model. The system outputs, as output data, structured data in a JSON format defining a specific action to be executed. The system outputs, as an example of the output data, a data object including an importance level of an alert, an administrator ID of a notification destination, and an overview explanation text of an incident. The system outputs, as another output example, a list of equipment IDs specifying an omission part of work. The system transmits the output structured data to a task management system as a subsequent process, and automatically issues an incident ticket. In optimization of a prompt, the system automatically fine-tunes a template of the prompt using a past inference result and feedback from an administrator as learning data. By this process, the system causes a computer to execute a complex situation judgment, which is difficult to describe in a rule-based system, through a natural language instruction. As a result, the system exhibits a technical effect of dramatically improving flexibility and adaptability of the system and enhancing defense capability against an unknown security threat. The system is applied to use cases such as autonomous security monitoring in a smart factory and behavior management of a customer and a staff member in an unmanned store. In order to speed up an inference process of the large language model, the system reduces a parameter size using a quantization technology of the model, and realizes low-latency inference on an edge device.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

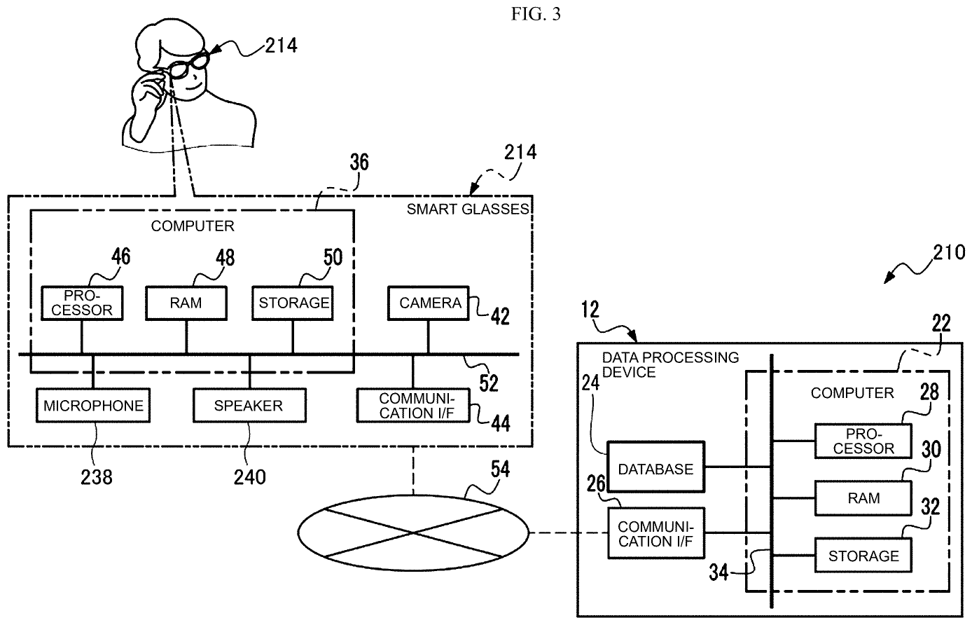

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

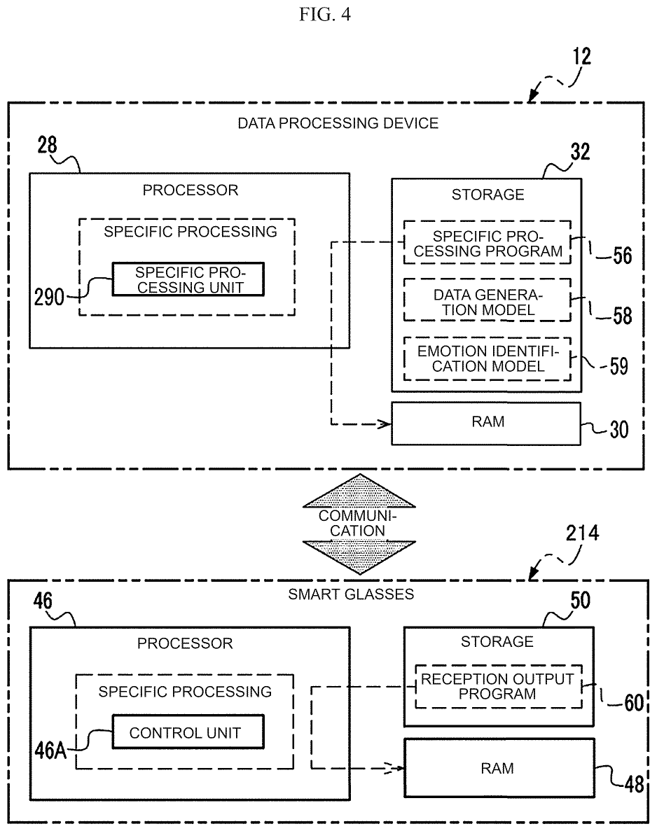

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

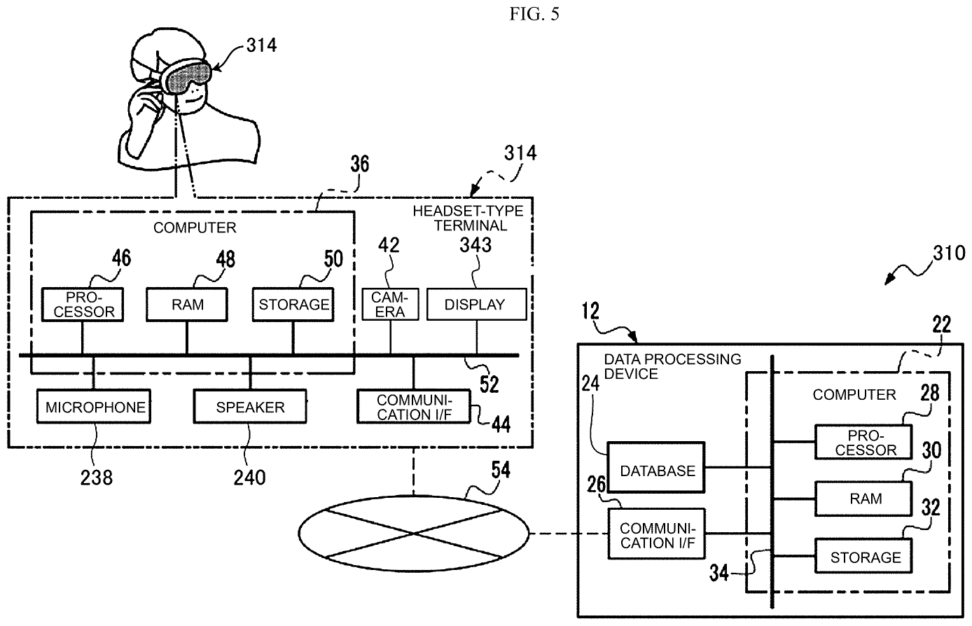

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

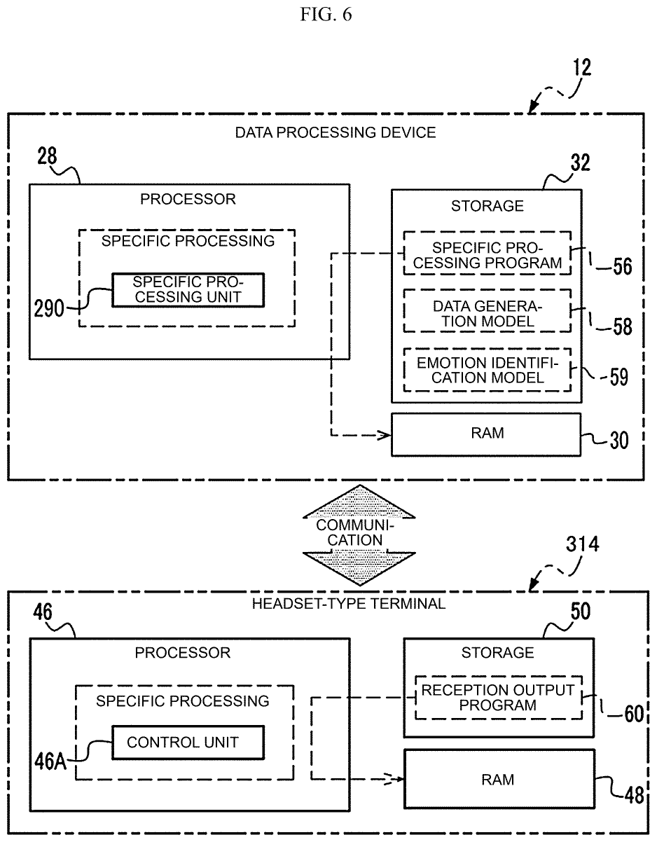

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

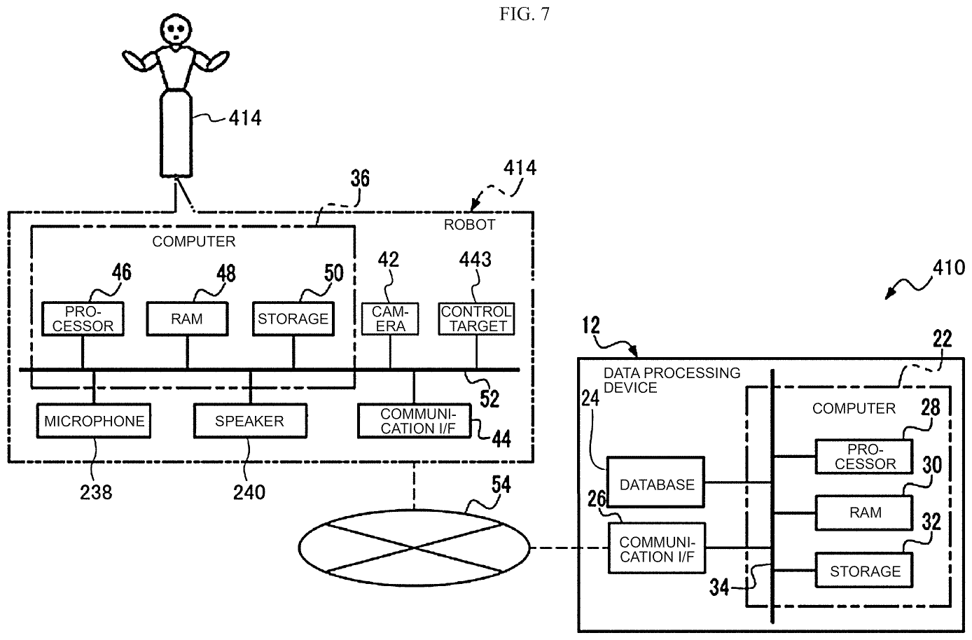

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

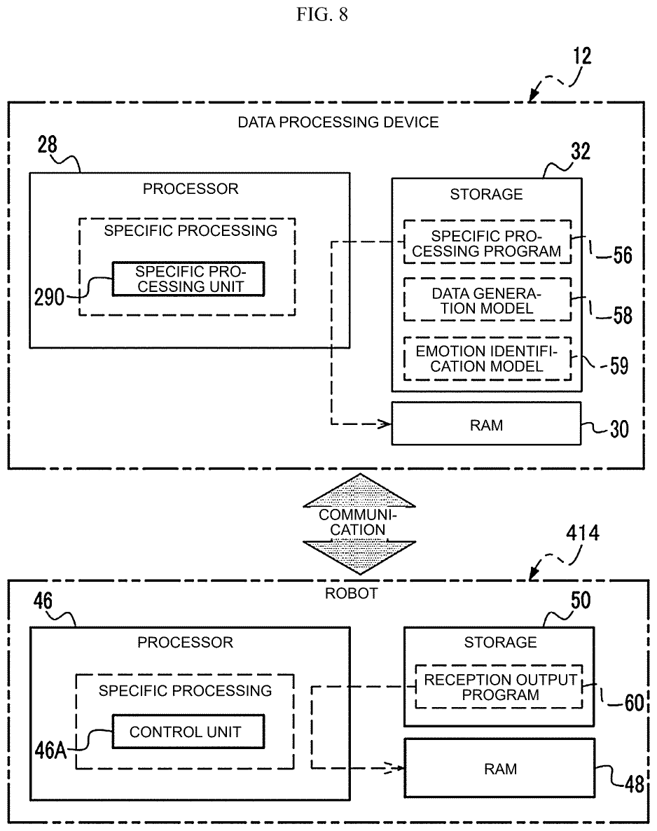

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

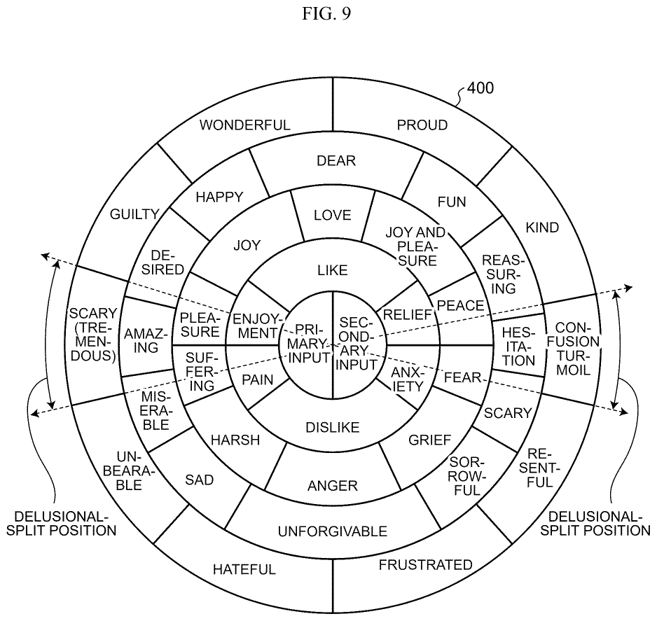

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

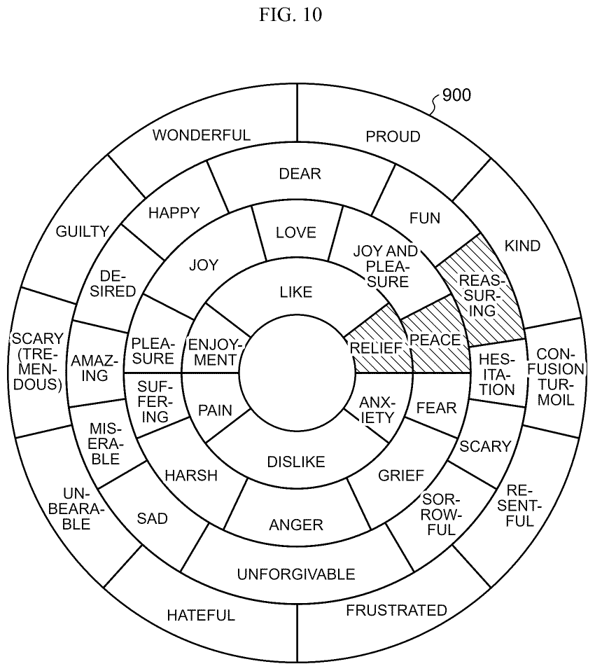

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

An access management system for a data center, comprising: a user information management unit; an authorization management unit; an audit record management unit; a generative AI processing unit; and an API cooperation unit, wherein the user information management unit centrally manages detailed attribute information such as a name, an ID, a role, an affiliated company, an enrollment status, contact information, shift information, an area in charge, and a past entry/exit history of an operation engineer, a maintenance worker, an outsourced contractor, a security personnel, a cleaning staff member, an equipment inspector, and the like who enter and exit the data center; the authorization management unit comprehensively analyzes the role, the affiliated company, a business content, a work schedule, qualification information, a past access record, and the like of each user using generative AI, automatically assigns a minimum and optimal logical access authority and physical access authority, receives event information such as joining, transfer, retirement, and start/end of a work period in real time via the API cooperation unit, and immediately executes assignment, change, or revocation of an authority of a corresponding user; the audit record management unit records in detail all account operations, authority changes, physical entry/exit records, logical system access records, data synchronization histories with an external system by API cooperation, and terminal information of all users together with time information; the generative AI processing unit integrally analyzes these pieces of information, detects an abnormal behavior, an authority setting error, and a tendency of personalization in real time, and performs risk notification and proposal of a corrective measure to an administrator; and the API cooperation unit performs data cooperation with an external human resource system, an entry/exit management system, an equipment management system, a cloud service, an on-premises system, and the like via an API, and realizes information synchronization and centralized access control of the entire system.

### Supplementary Note 2

The system according to Supplementary Note 1, wherein the generative AI processing unit analyzes a past physical entry/exit history and a logical system access history of a user, automatically extracts an abnormal pattern such as an access in an unusual time zone or area, an entry into a suspicious area by an outsourced contractor, or an access attempt by a retired user, notifies an administrator of the abnormal pattern in real time, and executes a process of immediately suspending or revoking the authority of the corresponding user as necessary.

### Supplementary Note 3

The system according to Supplementary Note 1, wherein the authorization management unit learns a role, an affiliated company, a work schedule, qualification information, a past access record, shift information, an area in charge, and the like of a user using the generative AI, dynamically assigns a temporary or permanent physical and logical access authority according to a work period and the area in charge, automatically revokes the corresponding authority at the end of the work period or at the time of a change in the area in charge, and records all authority change histories in the audit record management unit.

What is claimed is:

1. A system comprising:
circuitry configured to:
receive, via a communication interface coupled to a packet-switched network, user attribute data comprising organizational attribute parameters and lifecycle state parameters, operation event records, and sensor data streams from monitoring devices, and store the user attribute data, operation event records, and sensor data streams in a storage device;
generate an organizational attribute vector for each user by mapping the organizational attribute parameters and lifecycle state parameters to respective dimensions of a multidimensional attribute space;
apply a generative neural network model to the organizational attribute vector to compute a minimum access policy comprising access permission parameters specifying permitted resource identifiers and operation type identifiers;
detect anomaly access patterns by applying an autoencoder model pre-trained on operation event records representing normal access behavior to incoming operation event records, computing reconstruction error scores, and generating an anomaly signal when a reconstruction error score exceeds an anomaly threshold parameter;
update the access permission parameters in response to lifecycle event data received via the communication interface by revoking or modifying access permission parameters associated with the corresponding user attribute data; and
transmit updated access permission parameters and alert notifications to downstream authentication systems via the communication interface.

2. The system according to claim 1, wherein the circuitry is configured to receive streaming sensor data from IoT sensor devices located in a physical environment via the communication interface, apply a noise filter to the streaming sensor data, and input a time-series array of noise-filtered sensor data to the generative neural network model alongside the organizational attribute vector to generate a comprehensive security state score.

3. The system according to claim 2, wherein the circuitry is configured to apply an autoencoder model pre-trained on sensor data arrays representing normal operating conditions to incoming time-series arrays, compute a reconstruction error between the input sensor data array and the autoencoder output, and generate an environment anomaly signal when the reconstruction error exceeds an environment anomaly threshold parameter.

4. The system according to claim 3, wherein the circuitry is configured to issue a facility control command to a controllable device in the physical environment via the communication interface based on the environment anomaly signal, and transmit an alert notification to a terminal device specifying a three-dimensional coordinate data field indicating a location of an anomaly occurrence area.

5. The system according to claim 1, wherein the circuitry is configured to apply token-level positional encoding to operation event record text sequences prior to processing by the generative neural network model, extract named entity labels comprising resource identifier labels and operation type labels from the text sequences, and compute a behavioral pattern embedding vector from the named entity labels for comparison against a baseline behavioral pattern stored in the storage device.

6. The system according to claim 5, wherein the circuitry is configured to compare the behavioral pattern embedding vector against stored baseline behavioral patterns using cosine similarity scoring, generate an anomaly access pattern signal when a cosine similarity score falls below a similarity threshold parameter, and store the anomaly access pattern signal with a timestamp and a user identifier in an audit record data structure in the storage device.

7. The system according to claim 1, wherein the circuitry is configured to store all operation event records, access permission parameter changes, and system access histories in the audit record data structure associated with a timestamp and a user identifier, maintain the audit record data structure as a tamper-resistant append-only log, and transmit audit record data to a terminal device via the communication interface in response to a query request.

8. The system according to claim 7, wherein the circuitry is configured to apply the generative neural network model to the audit record data structure to identify unusual permission assignment patterns or access sequences, generate an anomaly report comprising identified unusual patterns and recommended corrective action data, and transmit the anomaly report to a terminal device via the communication interface.

9. The system according to claim 1, wherein the circuitry is configured to receive lifecycle event data indicating a state transition of a user lifecycle state parameter from a human resource data service via the communication interface, determine a set of access permission parameters to revoke or modify based on the state transition and the organizational attribute vector, and execute the revocation or modification of access permission parameters in real time by transmitting updated access control commands to downstream authentication systems.

10. The system according to claim 9, wherein the circuitry is configured to update the organizational attribute vector by incorporating the new organizational attribute parameters following a lifecycle state transition, re-apply the generative neural network model to the updated organizational attribute vector to compute an updated minimum access policy, and log the policy update as an operation event record in the audit record data structure.

11. The system according to claim 1, wherein the circuitry is configured to synchronize the access permission parameters with authentication infrastructure systems in a cloud computing environment and an on-premises environment via API cooperation using the communication interface, and apply a consistency verification check to confirm that access permission parameters stored in both environments are identical following each synchronization operation.

12. The system according to claim 11, wherein the circuitry is configured to detect inconsistencies in access permission parameters between the cloud computing environment and the on-premises environment during the consistency verification check, generate a remediation action sequence for resolving detected inconsistencies, and execute the remediation action sequence by transmitting corrective access control commands via the communication interface.

13. The system according to claim 1, wherein the circuitry is configured to update a machine learning model used for minimum access policy computation by generating training pairs from historical organizational attribute vectors and corresponding validated access permission parameters, and fine-tune the machine learning model on the training pairs to improve policy accuracy for specific organizational attribute patterns.

14. The system according to claim 1, wherein the circuitry is configured to enforce a token-based authorization check for all incoming requests to access or modify user attribute data or access permission parameters, and apply an access control policy limiting data modification operations to authorized administrative user identifiers associated with system administrator role parameters.

15. The system according to claim 14, wherein the circuitry is configured to encrypt all data transmissions between the system and downstream authentication systems using a transport layer security protocol, and perform mutual authentication using a digital certificate prior to transmitting updated access permission parameters to downstream authentication systems.

16. The system according to claim 1, wherein the circuitry is configured to generate a natural language explanation of each minimum access policy computed from an organizational attribute vector by applying the generative neural network model to the organizational attribute vector and a context data record comprising historical policy assignments and associated justification records, and transmit the natural language explanation to a terminal device.

17. The system according to claim 1, wherein the organizational attribute parameters comprise role identifier data and organizational unit identifier data, the lifecycle state parameters comprise enrollment state identifiers corresponding to active, transferred, and terminated states, and the minimum access policy comprises access permission parameters restricted to resource identifiers required for the organizational role.

18. A system comprising:
circuitry configured to:
receive, via a communication interface coupled to a packet-switched network, user attribute data comprising organizational attribute parameters and lifecycle state parameters, operation event records, and time-series sensor data streams from IoT monitoring devices;
generate an organizational attribute vector by mapping the organizational attribute parameters and lifecycle state parameters to a multidimensional attribute space, and apply a generative neural network model to the organizational attribute vector to compute a minimum access policy comprising access permission parameters;
detect anomaly access patterns by applying an autoencoder model pre-trained on normal operation event records to incoming operation event records, computing reconstruction error scores, and generating an anomaly signal when a reconstruction error score exceeds an anomaly threshold parameter;
apply a noise-filtered time-series array of sensor data to the autoencoder model to compute an environment anomaly signal based on reconstruction error from normal operating condition baseline data; and
update access permission parameters in response to lifecycle event data received via the communication interface and transmit updated access permission parameters and alert notifications to downstream authentication systems.

19. The system according to claim 18, wherein the circuitry is configured to synchronize the access permission parameters with authentication infrastructure systems in a cloud computing environment and an on-premises environment via API cooperation, detect inconsistencies between environments during consistency verification checks, and transmit corrective access control commands to resolve detected inconsistencies.

20. A method comprising:
receiving, via a communication interface coupled to a packet-switched network, user attribute data comprising organizational attribute parameters and lifecycle state parameters, operation event records, and sensor data streams from monitoring devices, and storing the user attribute data, operation event records, and sensor data streams in a storage device;
generating an organizational attribute vector for each user by mapping the organizational attribute parameters and lifecycle state parameters to respective dimensions of a multidimensional attribute space;
applying a generative neural network model to the organizational attribute vector to compute a minimum access policy comprising access permission parameters specifying permitted resource identifiers and operation type identifiers;
detecting anomaly access patterns by applying an autoencoder model pre-trained on operation event records representing normal access behavior to incoming operation event records, computing reconstruction error scores, and generating an anomaly signal when a reconstruction error score exceeds an anomaly threshold parameter;
updating the access permission parameters in response to lifecycle event data received via the communication interface by revoking or modifying access permission parameters associated with the corresponding user attribute data; and
transmitting updated access permission parameters and alert notifications to downstream authentication systems via the communication interface.
